(19) United States
(12) Patent Application Publication
(10) Pub. No.: US 2026/0097379 A1
(43) Pub. Date: Apr. 9, 2026

(54) Methods of Making Nanomaterial Dispersions and Nanocomposite Materials Produced by Dispersion Methods

(71) Applicant: Brown University, Providence, RI (US)

(72) Inventors: Benjamin Rebbeck McDonald, Portsmouth, RI (US); Aiden Saul, Providence, RI (US); Tharindu Ranathunge, Memphis, TN (US)

(21) Appl. No.: 19/351,196

(22) Filed: Oct. 6, 2025

Related U.S. Application Data
(60) Provisional application No. 63/703,669, filed on Oct. 4, 2024.

(51) Int. Cl. B01J 13/08; C08F 220/34; C08J 3/215; C08K 3/04; C08K 3/30; C08K 3/38

(52) U.S. Cl. CPC B01J 13/08; C08F 220/34; C08J 3/215; C08K 3/041; C08K 3/042; C08K 3/30; C08K 3/38; C08J 2333/14; C08K 2003/3009; C08K 2003/385; C08K 2201/011

(57) ABSTRACT

Methods of making composites of polymers and nanomaterials are provided. According to one aspect, a method for forming a nanocomposite by complexing a cationic polymer with a nanomaterial. The method includes the steps of: (1) dispersing a cationic polymer into a solvent, (2) dispersing a nanomaterial into the solvent; (3) increasing salt concentration to form a coacervate of the cationic polymer and the nanomaterial.

### CROSS-REFERENCE TO RELATED APPLICATION

This application claims benefit to U.S. provisional application 63/703,669 filed Oct. 4, 2024 and hereby incorporated by reference in its entirety.

### TECHNICAL FIELD

The present disclosure relates to methods of making compositions of polymers and nanomaterials.

### DESCRIPTION OF THE RELATED ART

Nanocomposites are materials that incorporate nanosized particles into a matrix of standard material. These materials have gained significant attention due to their enhanced mechanical, thermal, and electrical properties compared to their conventional counterparts. The integration of nanomaterials into polymers, metals, or ceramics can lead to significant improvements in strength, durability, and functionality. However, the process of forming nanocomposites can be complex and challenging, often requiring precise control over the dispersion and interaction of the nanomaterials within the host matrix.

One of the primary challenges in creating effective nanocomposites is controlling multiscale structure and achieving a uniform dispersion of nanomaterials within the matrix. Poor dispersion can lead to agglomeration, which negatively impacts the material's properties. Additionally, the interaction between the nanomaterials and the matrix must be carefully managed to ensure that the desired properties are achieved. Traditional methods of forming nanocomposites often involve complex chemical processes or high-energy inputs and mixing, which can be inefficient and costly.

Known methods for forming nanocomposites have involved various techniques such as physical blending, in-situ polymerization, and solution mixing. Physical blending typically involves mixing the nanomaterial with a polymer matrix, resulting in limited control over the dispersion and interfacial interactions between the components. In-situ polymerization methods entail the simultaneous formation of the polymer matrix and dispersion of the nanomaterial, which can be challenging to optimize for uniform distribution and desired properties. Solution mixing approaches have been utilized to disperse the nanomaterial within a polymer solution, but achieving a stable and homogeneous dispersion can be difficult to achieve consistently.

Methods have been proposed using electrostatic interactions to facilitate the assembly of cationic polymers with nanomaterials. By introducing oppositely charged species, such as anionic nanoparticles, into a cationic polymer solution, electrostatic attraction can drive the formation of complexes. However, controlling the assembly process and achieving a well-defined nanocomposite structure can be hindered by factors such as solution conditions, particle size, and charge density.

Additionally, salt-induced assembly techniques have been investigated for creating nanocomposites by manipulating the ionic strength of the solution to induce phase separation and coacervation. Methods are known to adjust salt concentration to promote the aggregation of cationic polymers and nanomaterials into coacervates, leading to the formation of nanocomposite structures. However, challenges remain in optimizing the salt-switchable cohesion process to achieve precise control over the nanocomposite morphology and properties.

As such, there is a need for more efficient and controllable methods for forming nanocomposites that can overcome these challenges and provide consistent, high-quality materials.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

According to one aspect, a method is provided for forming a nanocomposite by complexing a cationic polymer with a nanomaterial. An exemplary method includes the steps of: (1) dispersing a cationic polymer into a solvent, (2) dispersing a nanomaterial into the solvent; (3) increasing salt concentration to form a coacervate of the cationic polymer and the nanomaterial.

According to one aspect, methods described herein select ion identity to program the interaction between cationic polymers and anionic species for the regulation of solution phase behavior into fluids, gels, solids and the like. Additionally, this modulation of interparticle interaction allows the formation of organized fluid phases (liquid crystals) which can be kinetically trapped upon introduction of an anion with a distinct identity. Aspects of the present disclosure also utilize an ion-responsive polymer for the modulation of solution phase behavior as well as organization of nanomaterials across length scales ranging from 10 nm up to the micron length scale. These ion-responsive polymers of the present disclosure display chemical specificity in ion-binding allowing selection of ion identity and ion concentration to affect phase separation, assembly, structure and properties of the resulting composite.

Methods described herein include the steps of: (a) dispersing a cationic polymer into a solvent and inducing a salt switchable cohesion among the cationic polymer dispersion by increasing a salt concentration in the solvent; and (b) dispersing a nanomaterial in the solvent; whereby the nanomaterial also dispersed in the solvent forms a coacervate by a cohesion with the cationic polymer. A coacervate according to the present disclosure is a phase separated material including a cationic polymer, nanomaterial, solvent and salt. The cationic polymer is ion-responsive to the extent that it forms an aggregate or matrix in the presence of salt. When the nanomaterial is present with the ion-responsive cationic polymer, the addition of salt results in the nanomaterial becoming contained or dispersed within the aggregate or matrix to form the coacervate. The coacervate may be formed into a material, such as a liquid, gel, elastic material or solid material, having advantageous properties. The coacervate or material formed therefrom may include gaps, tunnels, networks or pores so as to accommodate an additional material therein, such as by infiltration, thereby imparting an advantageous property to the coacervate or material formed therefrom. Exemplary materials made from the coacervates include inks, gels, fibers and solid materials (such as load-bearing materials) that can be used in fabrication. According to one aspect, the coacervate may be subject to a second salt that forms an advantageous material, such as a solid material using a liquid to solid phase separation, from the coacervate. According to one aspect, the solvent used in the coacervate formation process may be polymerizable to form a solid material including the ion-responsive polymer and the nanomaterial. According to one aspect, the nanomaterial may exhibit alignment of the nanomaterial. Nanomaterials are known to those of skill in the art and include 0D nanomaterials such as metal oxide nanoparticles and the like, 1D nanomaterials such as carbon nanotubes, cellulose or chitin nanocrystals and 2D materials such as graphene, boron nitride, MoS₂, WSe₂ and the like. The coacervates may also include additional components that provide advantageous properties to the coacervate or material made therefrom. For example, a conducting additive may used during the coacervation formation process to impart electrical conductivity to the coacervate and a material made therefrom.

The present disclosure is directed to a system for forming a nanocomposite, the system including a cohesion inducer capable of complexing a cationic polymer with a nanomaterial via a salt induced assembly, the system including: (1) a concentration adjuster configured for dispersing a cationic polymer into a solvent and inducing a salt switchable cohesion among the cationic polymer dispersion by increasing a salt concentration in the solvent; and this is highly specific and sensitive to the chemical identity of the salt; and (2) a coacervate former configured for dispersing a nanomaterial in the solvent and for forming a coacervate by a cohesion with the cationic polymer.

The present disclosure is directed to a nanocomposite including a cationic polymer bonded with a nanomaterial via an ionic cohesion formed by a salt induced assembly; wherein the cationic polymer includes a salt switchable cohesion between the cationic polymer and the nanomaterial formed by increasing a salt concentration in a solvent including a dispersion of the nanomaterial and the cationic polymer; wherein the nanomaterial is in the form of a coacervate by the ionic cohesion with the cationic polymer.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The foregoing and other features and advantages of the present embodiments will be more fully understood from the following detailed description of illustrative embodiments taken in conjunction with the accompanying drawings in which:

FIG. 1 is a schematic showing use of a salt to create a coacervate using liquid-liquid phase separation and using a further salt to create a solid using liquid-solid phase separation and showing the solid composite as a disk and as the letter “B”.

FIG. 2 shows representative TEM images of select ensembles of nanosheets along with developed histograms.

FIG. 3 shows TEM micrographs displaying the impact of shear force on CNT length.

FIG. 4 shows a violin plot displaying density based size-distribution of CNT dispersions as a function of stir speed.

FIG. 5 shows AFM images and histograms displaying the height distribution of graphene, MoS₂, and WS₂ dispersions.

FIG. 6 shows representative Raman spectra displaying characteristic vibrational modes of graphene, MoS₂, and WS₂.

FIG. 7 is a graph depicting the shape/position of the 2D band of nanosheets produced by the LPE process described herein as compared to the shape/position of the 2D band of the graphite source used during LPE.

FIG. 8 is a graph of the absorbance spectra collected for MoS₂ and WS₂ dispersions.

FIG. 9 displays the phase diagrams across a variety of anion identities as a function of graphene and salt concentration.

FIG. 10 depicts select images of graphene condensates.

FIG. 11 is a graph of the zeta potential of graphene dispersions as a function of anion identity and concentration.

FIG. 12 depicts select images of graphene condensates formed at a concentration of 0.3M NaCl.

FIG. 13 depicts images of various graphene organizations.

FIG. 14 depicts images of various graphene organizations.

FIG. 15 is a graph of moduli versus oscillation strain.

FIG. 16 are graphs of modulus versus angular frequency.

FIG. 17 are graphs of modulus versus angular frequency and log(Crossover Frequency) versus log(Hydration Enthalpy) or the power law.

FIG. 18 displays the SEM of a range of graphene and graphene nanocomposite alloys fabricated by the salt-based method described herein.

FIG. 19 is a graph of stress versus strain displaying the displacement rate dependence of obtained nanocomposites.

FIG. 20 are graphs of stress versus strain showing that anion identity provides nanocomposites with qualitative and quantitative differences in stress-strain plots.

### DETAILED DESCRIPTION

Aspects of the present disclosure are directed to the making and using of ion and/or thermally responsive cationic polymers that undergo a variety of phase transitions. For example, ion responsive polymers form complexes with nanomaterials, such as 0D, 1D and 2D nanomaterials as are known in the art and as described herein. Aspects of the present disclosure provide a nanocomposite fabrication pathway using stimuli-responsive hierarchical self-assembly of a polymer with nanomaterials having inherent functionalities, wherein the polymer has a tunable structure and composition. Accordingly, the method described herein produces synthetic nanocomposites with hierarchical structuring which contributes to an increase in mechanical properties as well as affording composites with low densities (i.e. a high strength-to-weight ratio).

Aspects of the present disclosure contemplate the use of polymer phase separation behavior to properties of obtained polymer-nanomaterial complexes and their dispersions. For example, at a specific concentration of salt, dispersions undergo liquid-liquid phase separation to provide concentrated dispersions. According to one aspect of the present disclosure, these materials can additionally undergo subsequent liquid to solid transitions to provide freestanding structures at specific concentrations of distinct salt species According to one aspect, achieving dispersions of nanomaterials as described herein at an elevated concentration induces long-range orientational order of nanomaterials (referred to herein as “colloidal liquid crystallinity”). Based on the present disclosure, these ordered dispersions can be utilized to create solid materials. Such solid materials can be incorporated with existing additive manufacturing and reel-to-reel type processes to prepare a variety of material architectures. Such materials are lightweight and high strength while featuring a range of functionalities such as conductivity (electronic and thermal), sensing, and self-healing.

Aspects of the present disclosure are directed to a method for fabricating a nanocomposite through the complexation of a cationic polymer with a nanomaterial using a salt-induced assembly process. The method involves dispersing a cationic polymer in a solvent and utilizing this mixture to disperse nanomaterials. Subsequent elevation of the salt concentration in the mixture leads to the formation of a coacervate due to the cohesion between the nanomaterial and the cationic polymer. According to one aspect, the copolymer, the nanomaterial and the salt can be selected to create nanocomposites with desired properties for potential applications in various fields.

According to one aspect, colloidal dispersions of nanomaterials, such as 0D, 1D and 2D nanomaterials are generated from their bulk counterparts (e.g. graphite into graphene), via scalable solution-based processes. Via choice of salt, a variety of condensed polymer-nanomaterial composites are produced. When in fluid form, the composite can be used as inks or precursors for thin films, gels, and rubbery materials. Solid materials with high concentrations of well dispersed nanomaterials are produced from the composites. Aspects of the present disclosure also contemplate controlling nanomaterial organization during the macromolecular phase separation processes used in fabrication. Various material architectures are obtained by kinetically arrested phase separation, i.e. non-equilibrium assembly. According to one aspect, the ion-responsive polymer structure and composition can be selected or adjusted or tuned for interfacial interactions with nanomaterial or with other polymers enabling hierarchical self-assembly of nanomaterials and optimization of ionic conductivity as well as mechanical strength. According to the present disclosure, highly concentrated colloidal dispersions are produced, orientational alignment of nanomaterials (for hierarchical structure fabrication) is achieved, tunable synthetic nanocomposite material properties are generated via choice of stimuli, fabrication pathways including 4D lithography are provided whereby the addition of stimuli prior to lithography provides tunable material properties for high resolution tunable microstructure. The present disclosure further provides rational design of kinetically arrested phase separation, i.e. non-equilibrium assembly, by ion specific interactions.

According to some aspects, the techniques described herein relate to a method, wherein the cationic polymer is dispersed in a solvent by stirring, sonicating, or shaking to achieve a homogeneous cationic polymer dispersion prior to inducing the salt switchable cohesion.

In some embodiments, the techniques described herein relate to a method, wherein the nanomaterial is dispersed in the solvent by stirring, sonicating, shaking, or using a homogenizer to achieve a homogeneous nanomaterial dispersion.

According to some aspects, the techniques described herein relate to a method, wherein the solvent is used to disperse cationic polymer and nanomaterial. In some embodiments, the solvent is selected from any organic solvent and may be a polymerizable organic liquid used to disperse cationic polymer and nanomaterial.

In some embodiments, the techniques described herein relate to a method, wherein salt switchable cohesion is induced among a cationic polymer dispersion by increasing a salt concentration in the solvent, wherein the salt concentration is increased to a level sufficient to cause the cationic polymer chains to aggregate and form a cohesive network that is capable of interacting with the nanomaterial to form the coacervate.

According to some aspects, the techniques described herein relate to a method, wherein the salt concentration is increased in the solvent to induce cohesion, specifically, the salt concentration is increased gradually while monitoring the viscosity of a cationic polymer dispersion to ensure that the desired level of cohesion is achieved without precipitating the cationic polymer; and this is highly specific and sensitive to the chemical identity of the salt.

In some embodiments, the techniques described herein relate to a method, wherein the coacervate is formed by the nanomaterial by adhesion with the cationic polymer, and this process involves the nanomaterial being attracted to and encapsulated by the cohesive network of cationic polymer chains, resulting in a stable coacervate structure.

In some embodiments, the techniques described herein relate to a system, wherein a component mixer is configured to disperse a cationic polymer as described herein in a solvent as described herein by employing techniques such as stirring, sonicating, or shaking to ensure a uniform distribution of the cationic polymer within the solvent, thereby facilitating the subsequent salt switchable cohesion process.

According to some aspects, the techniques described herein relate to a system, wherein a component mixer is configured to disperse a nanomaterial as described herein in a solvent as described herein by employing techniques such as stirring, sonicating, shaking, or using a homogenizer to ensure a uniform distribution of the nanomaterial within the solvent, thereby facilitating the subsequent interaction with the cationic polymer to form the coacervate.

According to some aspects, the techniques described herein relate to a system, wherein a cohesion inducer is configured to induce salt switchable cohesion among the cationic polymer dispersion by increasing a salt concentration in the solvent, which is precisely controlled to achieve the desired level of cohesion necessary for the optimal interaction between cationic polymers and cationic polymer with the nanomaterial and the formation of a stable coacervate.

In some embodiments, the techniques described herein relate to a system, wherein a concentration adjuster is configured to increase the salt concentration in the solvent to induce cohesion, with the capability to fine-tune the salt concentration to modulate the properties of the resulting coacervate, such as its size, density, and stability, thereby allowing for the customization of the nanocomposite characteristics.

According to some aspects, the techniques described herein relate to a system, wherein a coacervate former is configured to form a coacervate by the nanomaterial by cohesion with the cationic polymer, ensuring that the coacervate formation is efficient and reproducible, leading to a consistent quality of the nanocomposite product.

In some embodiments, the techniques described herein relate to a method, further including adjusting the salt concentration to control the size of the coacervate, wherein the adjustment of the salt concentration is performed to achieve a coacervate size that is tailored for specific applications, such as drug delivery, catalysis, or sensor technology.

According to some aspects, the techniques described herein relate to a method, further including adjusting the salt concentration to control the density of the coacervate, wherein the density adjustment is critical for applications where the buoyancy or sedimentation rate of the coacervate in the solvent impacts the performance of the nanocomposite.

In some embodiments, the techniques described herein relate to a system, wherein a concentration adjuster is configured to adjust the salt concentration to control the size of the coacervate, providing a means to produce coacervates with a predetermined size range that is consistent and reproducible for the intended application of the nanocomposite.

According to some aspects, the techniques described herein relate to a system, wherein a concentration adjuster is configured to adjust the salt concentration to control the density of the coacervate, enabling the production of coacervates with specific densities that are optimized for their intended use in various industrial or biomedical applications.

In some embodiments, the techniques described herein relate to a method, further including selecting a cationic polymer to influence the properties of the nanocomposite, wherein the choice of cationic polymer is based on its molecular weight, charge density, topology and compatibility with the nanomaterial, which collectively contribute to the mechanical strength, thermal stability, and functional performance of the nanocomposite.

According to some aspects, the techniques described herein relate to a system, wherein a component mixer is configured to use a specific type of cationic polymer to influence the properties of the nanocomposite, wherein the selection of the cationic polymer is guided by the desired characteristics of the nanocomposite, such as its mechanical strength and toughness, electrical conductivity, magnetic responsiveness, or optical clarity.

According to some aspects, the techniques described herein relate to a nanocomposite, wherein the cationic polymer and the nanomaterial are selected such that the ionic cohesion between them provides a stable nanocomposite structure under predetermined conditions, and wherein the cationic polymer is characterized by a molecular weight, topology and charge density optimized to enhance the stability and mechanical properties of the nanocomposite, and the nanomaterial is chosen for its specific surface area, particle size, and functionalization to contribute to the overall properties of the nanocomposite.

In some embodiments, the techniques described herein relate to a nanocomposite, wherein the nanocomposite further includes additional components that modify the physical, chemical, or electrical properties of the nanocomposite, such components being selected from the group consisting of plasticizers, stabilizers, conductive fillers, and other polymers that are compatible with the cationic polymer and nanomaterial.

According to some aspects, the techniques described herein relate to a nanocomposite, wherein the nanocomposite exhibits enhanced thermal stability due to the ionic cohesion between the cationic polymer and the nanomaterial, which is achieved through the selection of the cationic polymer's molecular structure and the nanomaterial's thermal properties to resist degradation at elevated temperatures.

In some embodiments, the techniques described herein relate to a nanocomposite, wherein the nanocomposite demonstrates improved mechanical strength as a result of the optimized molecular weight, topology and charge density of the cationic polymer, which contributes to a robust network formation with the nanomaterial, enhancing the load-bearing capacity of the composite.

According to some aspects, the techniques described herein relate to a nanocomposite, wherein the nanocomposite possesses increased electrical conductivity facilitated by the inclusion of conductive fillers within the matrix, which are distributed in such a manner to create pathways for electron flow, thereby improving the electrical performance of the composite material.

In some embodiments, the techniques described herein relate to a nanocomposite, wherein the nanocomposite maintains its structural integrity under extreme environmental conditions due to the stability of the ionic cohesion, which is designed to withstand factors such as high temperatures, humidity, and exposure to harsh chemicals.

According to some aspects, the techniques described herein relate to a nanocomposite, wherein the nanocomposite is utilized in applications requiring biocompatibility, the cationic polymer and nanomaterial being selected based on their biocompatible properties, ensuring that the composite is non-toxic and safe for use in medical devices and implants.

In some embodiments, the techniques described herein relate to a nanocomposite, wherein the nanocomposite is designed for use in electronic devices, the properties of the cationic polymer and nanomaterial being tailored to meet the specific requirements of electronic applications, including flexibility, conductivity, and durability.

According to some aspects, the techniques described herein relate to a nanocomposite, wherein the nanocomposite includes a functionalization of the nanomaterial to specifically interact with targeted molecules, providing a means for selective binding or detection in chemical sensors, which enhances the sensitivity and specificity of the sensors.

### I. Ion-Responsive Polymers and Copolymers

Ion-responsive polymers and copolymers within the scope of the present disclosure are those that form an aggregate in the presence of salt. Ion-responsive polymers and copolymers include synthetic polymer structure to create cation-pi interactions as are known in the art. As described herein, such polymers undergo salt induced phase separation via salt switchable cohesion. According to one aspect, the increase in salt content screens long range repulsion and allows the short-range attractive interactions to form and dominate polymer behavior. According to one aspect, polymers described herein show ion specific interactions due to the difference in affinity between the cationic moiety on the polymer and anions in solution. According to one aspect, the present disclosure contemplates selecting the chemical identity and concentration of anions to influence the material properties of the resulting phase separated materials, with fluid-like coacervates, viscoelastic gels, or viscoplastic solids obtained as ion pairing interactions get stronger. According to one aspect, salt induced phase separation is thermoreversible and responds to additional salt. According to the present disclosure, a method is provided to tune the interaction of polymers and polymer coated materials, enabling the materials to be utilized in chemo- and thermoresponsive processes conventional and additive manufacturing methods. According to one aspect, organic solvents can be used in the practice of the present methods to make dispersions of the polymers or nanomaterials or both.

According to one aspect, cationic polymers described herein include adhesive & cohesive motifs for the salt induced assembly of nanocomposites, composites composed of polymers and nanomaterials. For example, mineral, metallic, polymeric, and carbon materials are generally characterized by negative surface potentials. The cationic polymers described herein provide strong interfacial adhesion to such surfaces. According to one aspect, the pi cloud of nanomaterials such as graphene, hexagonal boron nitride, and carbon nanotubes creates a negative surface potential which cationic materials adhere to via cation-pi interactions. Additionally, the cationic polymers can form complexes with anionic nanomaterials such as oxidized cellulose nanocrystals/nanofibrils, nanoclays such as montmorillonite, or base exfoliated aramid nanofibers. According to one aspect, methods are described to generate stabilized dispersions of nanomaterials as such nanomaterials are normally characterized with negative potential facilitating strong interactions with cationic polyelectrolytes for enhanced water solubility and stability.

According to one aspect, cationic polymers as described herein exfoliate graphite into dispersed graphene (4-6 layers by Raman), disperse carbon nanotubes, and hexagonal boron nitride, creating a surface coating that causes the properties of the salt responsive polymer to dominate the complexes behavior. Accordingly, the polymer/nanomaterial complex undergoes salt induced cohesion and liquid-liquid phase separation to directly provide fluid, ink-like materials, gels, and solid nanocomposites. The ion response properties of these fluids are used to fabricate devices with functionalities including electrical and thermal conductivity, structural color, and sensing via additive manufacturing technologies.

According to one aspect, a method is provided wherein salt induced formation of nanomaterial coacervates results in concentrated dispersions of nanomaterials into fluid, ink-like material precursors that are additionally salt responsive. According to this aspect, surpassing critical salt concentrations (that depends on the chemical identity of the salt added) in a polymeric/nanomaterial solution induces phase separation, i.e. coacervation, segregating polymer and nanomaterial into a condensed fluid, enriched in polymer and nanomaterial, thereby affecting the concentration of nanomaterial. Typical dispersions of 1 and 2D nanomaterials formed from the methods of the present disclosure typically in the range of 40-80 mg/mL. According to the present disclosure, coacervation of polymer/nanomaterial complexes yields concentrated dispersions of nanomaterials orders of magnitude higher in concentration, e.g., in the range of 40-80 mg/mL, than previously accessible. Solvents useful in the present methods include polar solvents such as water and alcohols, as well as organic solvents and deep eutectics.

Exemplary polymers and copolymers within the scope of the present disclosure include cationic polymers or copolymers. Exemplary polymers and copolymers include ionically responsive monomeric structures comprised of acrylate, acrylamide, vinylic, or ring-strained polymerizable motifs and similar analogues bearing ammonium, imidazolium, azolium, pyridinium, or other cationic analogues. Co-monomers comprised of but not limited to, acrylamide, N,N-dimethyl acrylamide, N-Isopropyl acrylamide, benzyl acrylamide, methyl acrylate, n-butyl acrylate, N,N-dimethyl amino ethyl acrylate, vinyl imidazole and other analogues capable of being polymerized with the ionically responsive monomer. According to one aspect, a cationic polymer can be selected to influence the properties of the nanocomposite, wherein the choice of cationic polymer is based on its molecular weight, topology, charge density, and compatibility with the nanomaterial, which collectively contribute to the mechanical strength, thermal stability, and functional performance of the nanocomposite. According to one aspect, a cationic polymer is selected to provide desired characteristics such as electrical conductivity in the range of 10\hat{ }−9 to 10\hat{ }9 S/m, magnetic susceptibility in the range of −10 to 10000 ppm, and optical clarity in the range of 10-100% transmittance

According to one aspect, the polymer or copolymer may be linear or crosslinked or exhibit a structure known in the art as a star, comb or bottlebrush.

### II. Nanomaterials

According to the present disclosure, nanomaterials described herein are typically characterized by high aspect ratios, or high length/width to thickness. This anisotropy enables them to behave as colloidal liquid crystals, or dispersed materials that undergo concentration induced spontaneous ordering. Methods described herein include salt induced aggregation of nanomaterial to produce a concentration of polymer and nanomaterial exceeding the critical concentration for spontaneous ordering, i.e. the isotropic to nematic transition in concentrated fluid phases. In conjunction with additional salt response, methods are provided to prepare synthetic nanocomposites via biomimetic bottom-up ordering processes facilitating manufacturing techniques. Exemplary composite material properties include light weight, high strength, strength, toughness, and energy dissipation.

Exemplary nanomaterials within the scope of the present disclosure include carbon-based nanomaterials (graphene, carbon nanotubes, buckyball, carbon microfibers), and their analogues (hexagonal boron nitride, boron nitride nanotubes), transition metal dichalcogenides (1, 2 and 3D), metal oxides, MXenes, cellulose nanocrystals, cellulose microfibers, hydroxyapaptite nanocrystals, and transition metal based nanomaterials comprised but not limited to gold nanowires (and the like), copper nanocubes, Cadmium selenide nanoparticles (and the like). Nanomaterials may be present in the composite in the range of 0.001 mg/mL to 1000 mg/mL.

### III. Salts

Exemplary salts useful in the methods described herein include any cation-anion pair comprised from cationic lithium, sodium, potassium, magnesium, calcium, copper, nickel, silver, gold, iron and anionic chloride, bromide, trifluoroacetate, nitrate, tetrafluoroborate, perchlorate, hexafluorophosphate, sulfate, 3,5-pyrocatecholdisulfonate tetrachloropalladate, and other analogues of anionic transition metal-based complexes. Exemplary salts are compatible with the solvents described herein. According to one aspect, a salt switchable cohesion is induced among a cationic polymer dispersion by increasing a salt concentration in the solvent. The salt concentration is increased to a level sufficient to cause the cationic polymer chains to aggregate and form a cohesive network that is capable of interacting with the nanomaterial to form the coacervate. According to one aspect, the salt concentration is increased gradually while monitoring the viscosity of the cationic polymer dispersion to achieve a desired level of cohesion without precipitating the cationic polymer. According to one aspect, salt concentration may be adjusted to control the size of the coacervate, wherein the adjustment of the salt concentration is performed to achieve a coacervate size that is tailored for specific applications, such as drug delivery, catalysis, or sensor technology. According to one aspect, the salt concentration is adjusted to control the density of the coacervate. Such adjustment may be performed to achieve a specific organization and long-range alignment of the constituent nanomaterial that is consistent and reproducible for the intended application of the nanocomposite. For example, adjusting the salt concentration is carried out to control the density of the coacervate, wherein density adjustment is important for applications where the buoyancy or sedimentation rate of the coacervate in the solvent impacts the performance of the nanocomposite.

### IV. Additional Components

Additional components to be included within the coacervate compositions as described herein include plasticizers, stabilizers, conductive fillers, and other polymers that are compatible with the cationic polymer and nanomaterial. Plasticizers include but are not limited to water, benzoates, citrates, phthalates and the like. Stabilizers include but are not limited to chitosan, polyethylene glycol (PEG), silica nanoparticles, mercaptosuccinic acid and the like. Conductive fillers include but are not limited to gold, nickel, palladium, copper, or iron nanoparticles. Additional polymeric components include but are not limited to poly(acrylonitrile), Poly(3,4-ethylenedioxythiophene), poly(butyl acrylate), poly(N,N-dimethyl acrylamide), poly(hydroxy ethyl acrylate), poly(acrylamide), poly(sodium styrene sulfonate), and the like. Additional components may be present in an amount of from 0.1 to 50 wt %.

### V. Solvents

Exemplary solvents useful in the methods described herein include polar solvents, organic solvents and polymerizable organic liquids. Exemplary solvents include at least one of water, ethanol, methanol, acetone, dimethyl sulfoxide (DMSO), isopropanol, butanol, tetrahydrofuran (THF), acetonitrile, N,N-dimethylformamide, 1,2-ethanedithiol and other di-, tri- and tetra-thiol analogues, ethylene oxide, propylene oxide and other epoxide bearing analogues, 4,4′-diphenylmethane diisocyante, 2,6-tolune diisocyante, methyl ester lysine diisociante and diisocyanate bearing analogs and the like which are used to disperse cationic polymer, nanomaterial or both. Solvent concentration ranges from 1-99% by volume.

### VI. Methods of Making Dispersions and Component Mixers

According to certain aspects, methods described herein contemplate generating a dispersion of a cationic polymer or a nanomaterial, or both. Methods of making dispersions are known to those of skill in the art and include stirring, sonicating, or shaking to achieve a homogeneous dispersion, such as by use of a homogenizer to achieve either a homogeneous dispersion of a cationic copolymer or a nanomaterial or both. Devices capable of stirring, sonicating, or shaking to achieve a homogeneous dispersion are known to those of skill in the art.

### VII. Cohesion Inducers

Cohesion inducer described herein refers to the method of dispersing nanomaterials. An exemplary cohesion inducer is a shear-based mixer. The scope of “cohesion inducers” for the preparation of colloidal dispersions includes but is not limited to sonication, ultrasonication, shear-based mixing, ball-milling and the like. Cohesion inducers within the scope of the present disclosure are suitable for complexing a cationic polymer with a nanomaterial via a salt induced assembly. According to one aspect, the cohesion inducer is configured to induce salt switchable cohesion among a cationic polymer dispersion by increasing a salt concentration in the solvent. The cohesion inducer is controlled to achieve the desired level of cohesion necessary for interaction with the nanomaterial and the formation of a stable coacervate.

### VIII. Concentration Adjusters

Concentration adjuster as it is referred to in this description is a method of salt delivery to induce phase separation or triggered assembly within dispersions. An exemplary concentration adjuster is a syringe pump. The rate of salt addition is important to attaining pre-determined properties of obtained nanocomposites. Concentration adjusters include but are not limited to syringe pumps, microfluidic syringe pumps, peristaltic pumps, elastomeric pumps, displacement pumps, osmotic pumps and the like.

Concentration adjuster within the scope of the present disclosure are suitable for dispersing a cationic polymer into a solvent and inducing a salt switchable cohesion among the cationic polymer dispersion by increasing a salt concentration in the solvent. According to one aspect, the concentration adjuster is configured to increase the salt concentration in the solvent to induce cohesion, with the capability to adjust the salt concentration to modulate the properties of the resulting coacervate, such as its size, density, and stability, thereby allowing for the customization of the nanocomposite characteristics. According to one aspect, the concentration adjuster is configured to adjust the salt concentration to control the size of the coacervate, providing a means to produce coacervates with a predetermined size range that is consistent and reproducible for the intended application of the nanocomposite. According to one aspect, the concentration adjuster is configured to adjust the salt concentration to control the density of the coacervate, enabling the production of coacervates with specific densities that are optimized for their intended use in various industrial or biomedical applications.

### IX. Coacervate Formers

As described herein, coacervate formation is induced by the addition of salt to dispersions. According to the present disclosure, the coacervate former may be the salt or it may be a separate device that forms the coacervates. Coacervate formers within the scope of the present disclosure are suitable for dispersing a nanomaterial in the solvent and for forming a coacervate by a cohesion with the cationic polymer. According to one aspect, the coacervate former is configured to form a coacervate by cohesion of a nanomaterial with a cationic polymer. According to one aspect, coacervate formation is efficient and reproducible, leading to a consistent quality of the nanocomposite product.

### X. Useful Characteristics of Nanocomposite Materials

According to one aspect, nanocomposite materials as described herein including a cationic polymer and a nanomaterial exhibit enhanced thermal stability due to the ionic cohesion between the cationic polymer and the nanomaterial, which is achieved through the selection of the cationic polymer's molecular structure and the nanomaterial's thermal properties to resist degradation at elevated temperatures.

According to one aspect, nanocomposite materials as described herein including a cationic polymer and a nanomaterial exhibit improved mechanical strength as a result of the optimized molecular weight, topology, and charge density of the cationic polymer, which contributes to a robust network formation with the nanomaterial, enhancing the load-bearing capacity of the composite.

According to one aspect, nanocomposite materials as described herein including a cationic polymer, a nanomaterial and conductive fillers within the nanocomposite matrix exhibit increased electrical conductivity, such as when the conductive fillers within the matrix are distributed in such a manner to create pathways for electron flow, thereby improving the electrical performance of the composite material.

According to one aspect, nanocomposite materials as described herein including a cationic polymer and a nanomaterial exhibit structural integrity under extreme environmental conditions due to the stability of the ionic cohesion, which is designed to withstand factors such as high temperatures, humidity, and exposure to harsh chemicals.

According to one aspect, nanocomposite materials as described herein including a cationic polymer and a nanomaterial exhibit biocompatibility, where the cationic polymer and nanomaterial are selected based on their biocompatible properties, to provide a nanocomposite that is non-toxic and safe for use in medical devices and implants.

According to one aspect, nanocomposite materials as described herein including a cationic polymer and a nanomaterial exhibit utility in electronic devices, where the properties of the cationic polymer and nanomaterial are selected to meet requirements of electronic applications, including flexibility, conductivity, and durability.

According to one aspect, nanocomposite materials as described herein including a cationic polymer and a nanomaterial may be functionalized to specifically interact with targeted molecules, so as to provide a means for selective binding or detection in chemical sensors, which enhances the sensitivity and specificity of the sensors.

Polymer/nanomaterial complexes described herein undergo salt induced cohesion and liquid-liquid phase separation to directly provide fluid, ink-like materials, gels, and solid nanocomposites. The ion response properties of these fluids are advantageous in fabricating devices with functionalities including electrical and thermal conductivity, structural color, and sensing via additive manufacturing technologies.

According to one aspect, the salt induced formation of nanomaterial coacervates concentrates dispersions of nanomaterials into fluid, ink-like material precursors that are additionally salt responsive. According to the present disclosure, surpassing critical salt concentrations (that depends on the chemical identity of the salt added) in a polymeric/nanomaterial solution induces phase separation, i.e. coacervation, segregating polymer and nanomaterial into a condensed fluid, enriched in polymer and nanomaterial, thereby affecting the concentration of nanomaterial.

Methods are provided herein for the use of highly concentrated dispersions of graphene and/or mixtures with other nanomaterials such as metal oxides, carbon nanotubes, hexagonal boron nitride, or transition metal chalcogenides as fluid dispersions for use as manufacturing precursors. These dispersions are used as inks for various printing based additive manufacturing methods or conventional reel-to-reel processes. According to one aspect, the salt responsive nature of these dispersions is used to create tissue-like, multiscale structures. For example, salt is used to pre-assemble a photoreactive nanocomposite in a 4D lithographic method. Light induced crosslinking creates differences in crosslinking density, whereby upon response to a second salt the material collapses, creating tension at the crosslinked areas. This create areas of high stiffness, creating tensile strength, while the uncrosslinked areas serve as energy dispersing zones, in analogy to the function of biological nanocomposites. The collapse mechanism results in stiff materials.

Composites as described herein exhibiting salt responsiveness can function as electrochemical actuators. Electrochemical methods (e.g. capacitive) can change concentration of salt, cause nanomaterial swelling to change. Such materials could be manufactured by the methods described above.

Composite materials as described herein can be used as impact resistant and energy dispersing materials such as those used in personal protection (body armor). Additional functions such as conductivity (to create a nervous system in armor) or dynamic stiffening (switchable from soft, compliant state, to stiff protective state).

Composite materials as described herein can be used as electrochemical storage components, such as robust electrodes or electrolytes for supercapacitors or metal ion batteries. Composite materials as described herein can be used to structure electrochemical energy storage devices, enabling them to serve as load bearing materials. The marriage of these mechanical properties with enhanced ion conduction, which is seen in aligned nanocomposites, would further enable multifunctional energy storage, i.e. batteries/capacitors able to bear a mechanical load. Such products would be structural batteries, energy storage devices that are incorporated into the frame of vehicles. Such technology is required to address the significant weight created by battery compartments.

Composite materials as described herein can be used as conductive plastic materials. According to one aspect, high loadings of oriented nanomaterials creates plastic composites with directional ionic, thermal, and electrical conductivity.

According to one aspect, methods of the present disclosure can be carried out on a commercial scale. The polymers utilized are made from either commercially available monomers or single step synthesis that requires no purification. The polymer can be prepared by simple free radical polymerization and isolated by precipitation. Dispersions are formed by stirring bulk nanomaterial precursors. As a proof-of-concept, graphite, available for <$100 per kilo, was dispersed into a graphene solution by simple stirring with heating and slow addition of the polymer. This is fundamentally scalable. Purification of the graphene is performed by a combination of gravity and centrifugation. The latter is accomplished by cross flow filtration or other fluidic filtration techniques that utilize centripetal force (centrifugal filtration). At laboratory scale, the methods described herein has provided >250 mL of dispersion and could be facilely scaled to provide liter scale quantities of dispersions (0.1-10 mg/mL concentration), that upon salt addition can provide condensates enriched to 40-100 mg/mL or greater. These methods have been additionally adapted to the dispersion of multiwall carbon nanotubes (MWCNTs), molybdenum sulfide, tungsten sulfide, and hexagonal boron nitride. Thus, the present disclosure provides dispersions of unprecedented concentration that could be scaled into an industrial process.

Aspects of the present disclosure is directed to providing structural organization in nanocomposite. Methods described herein promote long-range pre-alignment of nanomaterials prior to material fabrication via concentration induced liquid crystallinity, so as to provide fluid material precursors with nanomaterial organization that can be incorporated into the final material in traditional or additive manufacturing processes. This long-range order, tunable by salt, polymer concentration, and nanomaterial dimensions/concentration, enables triggerable assembly of precursor material for hierarchical synthetic nanocomposite architectures. Notably, this approach can be incorporated into existing shear-based fiber spinning methods and 3D printing methods. Methods describe herein can be used to provide direct control on the organization of the desired nanomaterial along different points of the material fabrication process.

Methods of the present disclosure allow preparation of nanocomposites that are thermally responsive or electrochemically responsive, allowing materials to expand or contract.

Given the similar properties of the interfaces of solid materials such as mineral, metallic, polymeric, and carbon materials, cationic polymers form strong interfacial interactions with a variety of nanomaterials, including metal oxides, minerals/clays, graphene, 2D metal chalcogenides, carbon nanotubes, buckyballs, hexagonal boron nitride, cellulose nanocrystals, etc. all of which have functions in a variety of applications including coatings, electronic devices, etc. Methods disclosed herein can utilize one or more of these nanomaterials in a nanocomposite. According to one aspect, nanocomposites exhibit responsiveness to magnetic and/or electric fields.

According to one aspect, both structure of polymer interfaced with nanomaterial and interfaced with other polymers in a nanocomposite can be varied. Similar to protein structure, the polymer adhering to the surface of the nanomaterials can be varied in chemical composition and structure. This enables tuning of the interfacial interaction strength. Varying the structure of the interstitial polymer impacts cohesive interactions of polymer interconnecting the nanomaterial. Composite materials described herein exhibit strength, toughness, and energy dissipation, useful in energy dispersive materials.

### XI. Liquid Phase Exfoliation

According to certain embodiments, a method of liquid phase exfoliation is provided herein to exfoliate layered nanocomposites described herein. The role of cationic polymer as described herein is to stabilize resulting graphene (or other nanomaterial dispersions). As is known in the art, the simple input of mechanical energy is sufficient for the production of graphene, however, if this is performed in water, the resulting dispersion is highly unstable. Cationic polymers serve to enhance the stability of nanomaterials in water.

Layered materials includes but are not limited to carbonaceous graphene and its structural analogues (hexagonal boron nitride (hBN)), transition metal dichalcogenides (TMDs) (molybdenum sulfide (MoS₂), tungsten sulfide (WS₂) etc.), layered double hydroxides, etc., are characterized with atomically thin planes bound by covalent interactions that form 3D structures which are held together by weak out-of-plane van der waals interactions. The orders of magnitude difference between in-plane and out-of-plane binding energy allows this class of material to be exfoliated into atomically thin crystalline structures, known as two-dimensional (2D) materials or crystals, by an input of mechanical energy. Traditionally, this input of energy has been comprised of adhesive interactions from commercially available Scotch tape which adheres to the surface of bulk layered crystals separating them into thinner materials as the Scotch tape is peeled away, i.e. exfoliating the bulk layered crystal. To get to atomically thin layers requires repetition of this process many times to produce low yields of high quality 2D crystals.

Liquid phase exfoliation (LPE) is an alternative pathway to the exfoliation of layered materials wherein mechanical shear or ultrasound induced sonication is used as the energy source to disrupt interlayer interactions in the bulk crystal resulting in its efficient separation. Conducted in the solution phase, LPE is inherently more scalable than Scotch tape-based exfoliation and provides relevant precursors for subsequent material fabrication via manipulation of solvation environment.

The disclosure of the certain embodiments is further provided in the following Examples. In the experiments described herein, the following materials were used without further purification: N,N-dimethyl amino ethyl acrylate (TGI Chemicals), benzyl bromide (Sigma-Aldrich), 4,4′-Azobis(4-cyanovaleric acid) (Sigma-Aldrich), acrylamide (Sigma-Aldrich), graphite (Sigma-Aldrich), sodium chloride (Sigma-Aldrich), sodium triflate (Sigma-Aldrich), sodium hexafluorophosphate (Sigma-Aldrich), molybdenum sulfide powder (Sigma-Aldrich), tungsten sulfide powder (Sigma-Aldrich), boron nitride nanopowder (US Research Nanomaterials), multiwalled carbon nanotubes (OD: <7 nm) (US Research Nanomaterials). Deuterated solvents were obtained from Cambridge Isotope Laboratories.

### Example I

### Synthesis of an Ion-Responsive Monomer

N,N-dimethyl amino ethyl acrylate (48 mL, 0.313 mol) was dissolved in acetone (500 mL) and cooled to 0° C. Benzyl bromide (BnBr) (31 mL, 0.261 mol) was added dropwise across about 1 hr and the reactants were stirred overnight. The product precipitated as a white crystalline solid that was collected via vacuum filtration and washed with 3×50 mL acetone to give (1) in 87% yield. ¹H NMR (400 MHz, D₂O) δ 7.65-7.54 (m, 5H), 6.48 (d, J=18 Hz, 1H), 6.24 (q, J=8 Hz, 1H), 6.04 (d, J=12 Hz, 1H), 4.72 (s, 2H), 4.61 (s, 2H), 3.80 (t, J=4, 2H), 3.15 (s, 6H). The reaction is provided below.

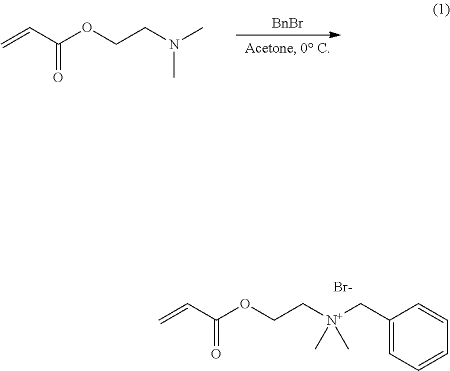

### Example II

### Synthesis of an Ion-Responsive Copolymers (A1M1)

A clean, oven dried 500 mL RBF equipped with a stir bar was cooled under nitrogen. DI water (100 mL) was added to the flask and sparged overnight (about 8 hours). Acrylamide (1.26 g, 17.85 mmol) and (1) (5.61 g, 17.85 mmol) were then added to the flask followed by addition of 4,4′-Azobis(4-cyanovaleric acid) (0.05 g, 0.18 mmol). The reaction mixture was set to sparge for about 15 minutes and then stirred for 5 hours at 65° C. Polymerization progress was monitored via ¹H NMR to ensure even total consumption of monomer. The polymerization mixture was then concentrated under reduced pressure followed by precipitation in acetone. The white crystalline product was washed with acetone (3×50 mL) and dried under high vac overnight. The following day the product was made into a fine powder via mortar and pestle and placed under high vac overnight to yield A1M1 as a white crystalline powder.

### Example III

### Preparation of Colloidal Dispersions

To produce colloidal dispersions of graphene, MoS₂ and WS₂, solutions of ion-responsive polymer (A1M1) (40 mg/mL) were injected via syringe pump (0.833 L/s) to a stirred (1500 R.P.M) and heated (65° C.) suspension of nanomaterial powder in DI water (100 mg/mL) across 24 hours. Stirring and heating were continued for an additional 24 hours post polymer injection. Nanomaterial suspensions were divided equally into 50 mL Falcon tubes and centrifuged (1790 r.c.f., 10 minutes). The top 80% of supernatant was collected and subjected to an additional centrifugation cycle (12000 r.c.f, 30 minutes for graphene dispersions, or 4000 r.c.f, 30 minutes for MoS₂, and WS₂, dispersions) followed by isolating the top 80% of supernatant for use as ion-responsive dispersion.

To produce colloidal dispersions of CNTs, solutions of ion-responsive polymer (A1M1) (15 mg/mL) were injected via syringe pump (0.370 L/s) to a stirred (1500 R.P.M) suspension of CNT powder in DI water (10 mg/mL) across 12 hours. Stirring was continued for an additional 12 hours post polymer injection. (Note: CNT dispersal was conducting across 24 hr. as opposed to 48 hr. for 2D materials to preserve aspect ratio.) CNT suspensions were divided equally into 50 mL Falcon tubes and centrifuged (1790 r.c.f., 10 minutes). The top 80% of supernatant was collected and subjected to an additional centrifugation cycle (4000 r.c.f., 30 minutes) followed by isolating the top 80% of supernatant for use as ion-responsive dispersion.

To produce colloidal dispersions of hBN, solutions of ion-responsive polymer (A1M1) (10 mg/mL) were injected via syringe pump (0.833 uL/s) to a suspension of hexagonal boron nitride nanopowder in DI water (25 mg/mL) in an ice bath. Exfoliation was conducted in an ice bath under ultrasonication using a Qsonica Sonicator Q125 using an amplitude of 40% with an on/off cycle of 5 seconds. Ultrasonication was let run for 3 hours. Dispersions of hBN were divided equally into 50 mL Falcon tubes and centrifuged (1790 r.c.f., 10 minutes). The top 80% of supernatant was collected and subjected to an additional centrifugation cycle (4000 r.c.f., 30 minutes) followed by isolating the top 80% of supernatant for use as ion-responsive dispersion.

### Example IV

### Preparation of Nanocomposites from Colloidal Dispersions Using Salt

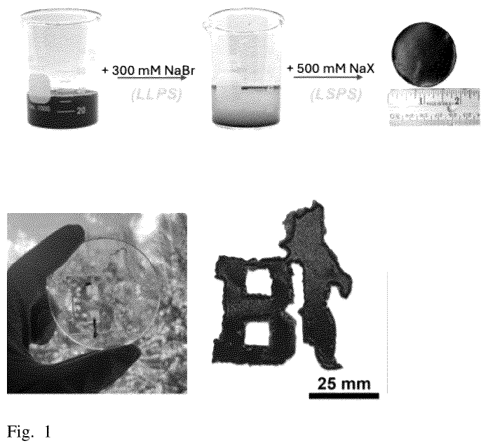

Thin-film nanocomposite and nanocomposite alloys were fabricated by the dropwise addition of NaBr (1.2M, 20 mL, 11 uL/s, 30 minutes) to colloidal dispersions/blends (60 mL) to induce liquid-liquid phase separation (LLPS) (see FIG. 1). Microphase separated solutions were let sit overnight to yield a thin, dense nanomaterial gel-phase. The dilute phase was decanted and the gel phase treated with 3×50 mL of 0.5M chaotropic salt solutions followed by removing the thin film from the bottom of the fabrication vessel and letting sit in solution overnight. The chaotropic salt solutions served the purpose of induced liquid-solid phase separation of the gel-like phase as informed by the power law plotting log of Crossover frequency vs. log of hydration enthalpy. Identities of anions used for LSPS include but are not limited to BF₄⁻, ClO₄⁻, PF₆⁻, and PdCl₄²⁻ as well as other analogues. This fabrication pathway was demonstrated to be applicable to the fabrication of nanocomposites with varying identities including but not limited to; graphene, MoS₂, WS₂, hBN, as well as complex nanocomposite alloys including but not limited to; graphene-co-MoS₂ and graphene-co-CNT.

According to one aspect, the nanocomposite fabrication pathway described above is used for the fabrication of spatially templated thin-film nanocomposites. Negatives were fabricated by laser cutting designed images out of acrylic sheets. The negative was shaped to fit in the bottom of a 500 mL beaker. The method above was then used to fabricate spatially templated nanocomposites by adding a further salt to induce liquid to solid phase separation. (See FIG. 1).

The shear rate throughout dispersal of CNTs was modified to characterize its impact on the dimensions of obtained nanotubes. The same procedure was carried out as above except utilizing 1000 R.P.M stirring speed. Samples were collected after 24 hours and isolated by the multistep centrifugation process as described above.

### Example V

### Characterization of Colloidal Dispersions: Transmission Electron Microscopy

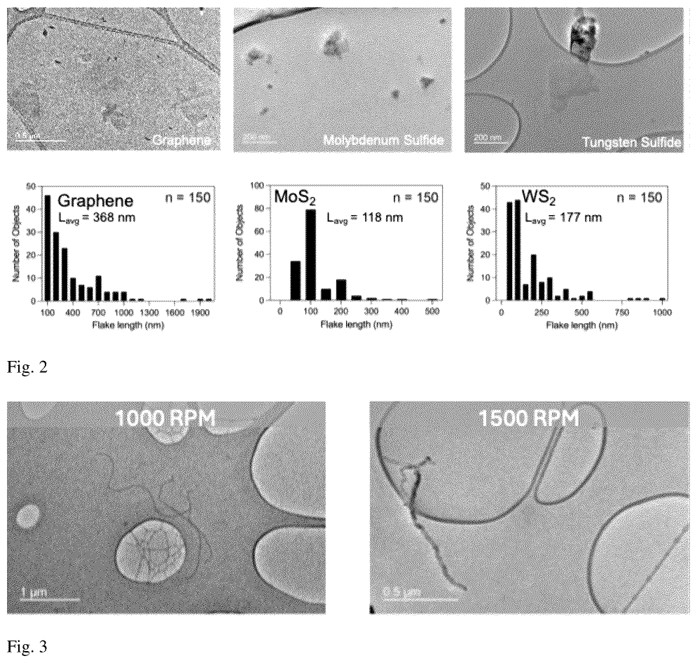

Transmission electron microscopy (TEM, JEOL 2100F-S(TEM)) was used to characterize the lateral dimensions of obtained dispersions. Samples were prepared from diluted dispersions (10 uL dispersion: 90 uL ethanol) to minimize nanomaterial aggregation. The diluted dispersions were drop-casted onto TEM grids (lacey carbon film—Cu 200 mesh) by drop casting 10 μL of dispersion (10 uL dispersion: 90 uL ethanol) and using the edge of a Kim wipe to remove excess dispersion. Images were collected using 200 kV field emission. Obtained images were analyzed in ImageJ using the line tool after calibrating scale. Histograms of nanosheet and nanotube length were made-up from the measurement of at least 150 nanoparticles per dispersion. Representative TEM images of select ensembles of nanosheets are displayed in FIG. 2 along with developed histograms. Developed histograms show log-normal distributions of nanosheet length. The average length for graphene, MoS₂, and WS₂ was determined to be 368 nm, 118 nm, and 177 nm, respectively. Lateral dimensions of nanosheet dispersion are comparable to literature reported results of shear-based LPE.

FIG. 3 are TEM micrographs displaying the impact of shear force on CNT length. As shear rate is reduced a lesser force is exerted on the CNT bundles reducing fracture and providing higher aspect ratio (i.e. length to width ratio) particles.

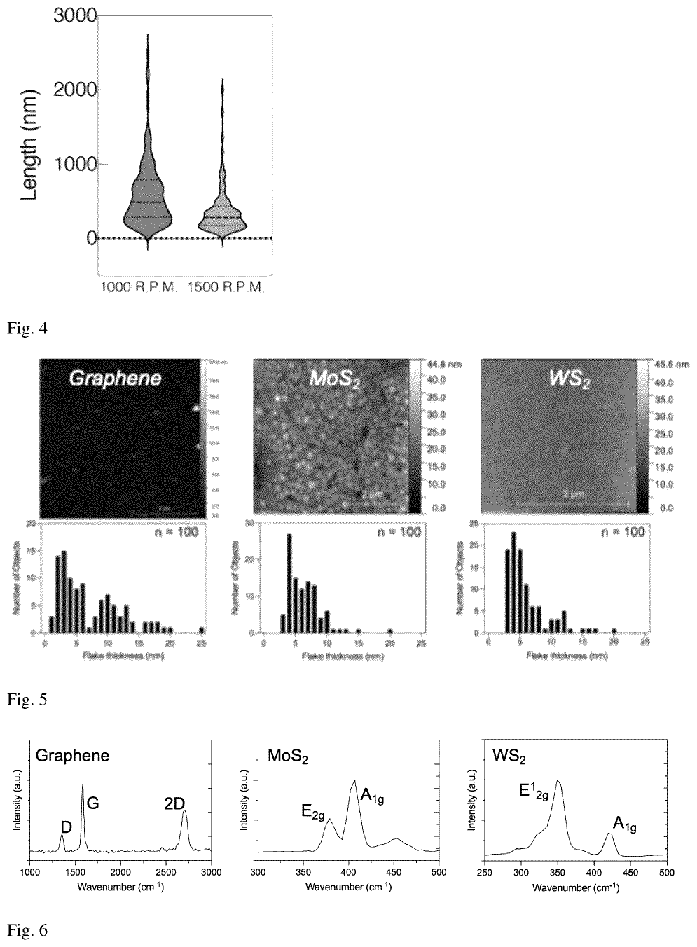

FIG. 4 is a violin plot displaying density based size-distribution of CNT dispersions as a function of stir speed. Dispersions produced at 1000 R.P.M. display a greater density of particles with longer dimensions.

### Example VI

### Characterization of Colloidal Dispersions: Atomic Force Microscopy

Atomic Force Microscopy (AFM) (MFP-3D-BIO, Asylum Research) was used in AC (tapping) mode to probe the thickness of colloidal dispersions. Samples were prepared by diluting dispersions until transparent (10 uL dispersion: 90 uL ethanol) to minimize nanomaterial aggregation. 10 μL of diluted dispersion was drop-casted onto freshly cleaved Mica heated to ˜110° C.

Processing of AFM data was performed using Gwyddion, an open-source software commonly used in literature for AFM analysis. Background correction was achieved by mean-plane subtraction. Height profiles of select nanosheets were obtained using the line tool. Height profiles of at least 100 nanosheets were collected for each dispersion.

Histograms produced from the statistical analysis of 2D dispersions display log-normal distributions which is commonly observed for the shear-based LPE of 2D materials. FIG. 5 are AFM images and histograms displaying the height distribution of graphene, MoS₂, and WS₂ dispersions. The adsorption of polymer chains as well as residual solvent complicates the height determination of 2D nanosheets by AFM. As a result, it has been demonstrated in literature that the average thickness of a true monolayer is much greater than its theoretically predicted value. The average thickness as determined by AFM for graphene, MoS₂, and WS₂ is ˜6 nm corresponding to few to many-layered 2D materials. The thickness of obtained dispersions compares well to 2D dispersions produced by shear-based LPE in literature.

### Example VII

### Characterization of Colloidal Dispersions: Raman Spectroscopy

Raman spectroscopy is used as a characterization method for the determination of 2D material quality and thickness. The basis for characterization of 2D materials by Raman spectroscopy is rooted in modulation of the electronic structure of bulk (3D) layered crystals as the number of layers are reduced and thickness becomes increasingly confined to the nano-regime, i.e. atomically thin or few to many-layered 2D materials. This reduction in thickness, and therefore interlayer interactions, results in modulation of the vibrational properties of 2D materials. For instance, in going from bulk graphite to the monolayer regime (i.e. 1-layer thick graphene), the 2D vibrational mode of graphene (˜2700 cm⁻¹) displays a change in shape as well as a reduction in the energy. The variation in peak shape and position of the 2D band in graphene has thus been quantified as a function of layering, providing a convenient means for characterizing the number of layers present in a graphene nanosheet. Alternative vibrational modes have been found to provide quantitative insight into the layering of transition metal dichalcogenides such as MoS₂ and WS₂, wherein variations of E_{2g} and A_{1g} vibrational modes are used to assess layering.

The intensity of specific vibrational modes also provides insight into the quality of nanosheets. For graphene, the ratio of the D band (˜1350 cm⁻¹) to the G band (˜1580 cm⁻¹) provides insight into the defects present on a specific nanosheet. These defects may arise from the disruption of graphene's regular honeycomb lattice or oxidation resulting in sp³ hybridized carbon providing higher intensities of the D band.

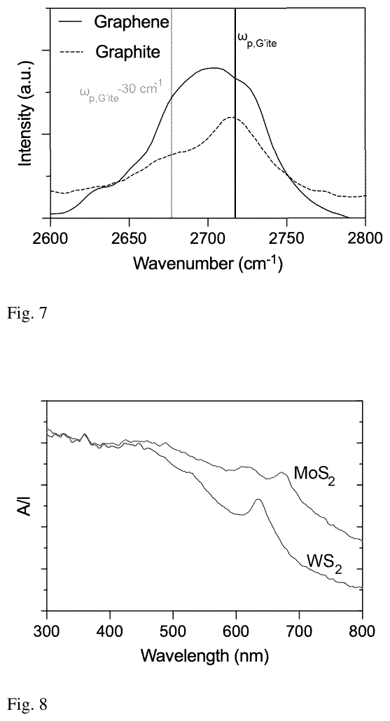

Raman spectra were recorded on a Witec Alpha 300 confocal microscope with a 532 nm excitation source. Samples were prepared by spin-coating (3000 R.P.M, 60 seconds) diluted dispersion (10 uL dispersion:90 uL ethanol) onto confocal microscopy slides. Spectra of single nanosheets were obtained by focusing with a 100× objective. Obtained spectra were processed by background subtraction prior to analysis. For Raman spectroscopy on bulk 2D material, flakes were placed onto the surface of a confocal microscope slide and analyzed across multiple points to obtain an average spectrum. FIG. 6 depicts Representative Raman spectra displaying characteristic vibrational modes of graphene, MoS₂, and WS₂. Obtained Raman spectra display vibrational modes characteristic of the specific nanomaterial indicating preservation of crystal structure throughout the LPE process (see FIG. 6). For gaining insight into the layering of graphene, analysis of the 2D band was conducted across at least 100 nanosheets. Using quantitative formulas derived by Coleman et al., DOI: 10.1038/NMAT3944, Paton et. al., scalable production of large quantities of defect-free few-layer graphene by shear-exfoliation in liquids, Nature Materials, 13, 624-630, 2014, the shape/position of the 2D band of nanosheets produced by the LPE process described herein was compared to the shape/position of the 2D band of the graphite source used during LPE (see FIG. 7). The average number of layers for each graphene nanosheet was determined to be about 4 to 6, supporting data from AFM indicating that samples were few to many-layered nanosheets. Analysis of the E_{2g} and A_{1g} vibrational mode positions were used to assess layering in MoS₂ an WS₂. It has been reported that in going from the bulk to the monolayer regime in MoS₂, the E_{2g} mode stiffens (i.e., shifts towards higher frequencies) while the A_{1g} mode softens (i.e. shifts towards lower frequencies). This has been used to resolve the layering of MoS₂ nanosheets containing less than 4 layers, as above this the vibrational mode positions converge to the bulk values. Across 100 nanosheets, the Raman spectra of MoS₂ displayed E_{2g} and A_{1g} vibrational mode positions of 4 or more layers, supporting the claim that nanosheets were few to many-layers.

### Example VIII

### Characterization of Colloidal Dispersions: UV-Vis Spectroscopy

UV-Vis spectroscopy was used to characterize the optical properties of TMD dispersions (i.e., MoS₂ and WS₂). Samples for UV-Vis were prepared by adding a discrete amount of dispersion to an Eppendorf 952010069 Uvette® and measuring with a Thermo Scientific Evolution 350 UV-Vis spectrophotometer. Absorbance spectra were collected with a path length of 2 mm from 800 to 300 nm. See FIG. 8. displays the absorbance spectra collected for MoS₂ and WS₂ dispersions. Absorbance bands at ˜670 nm and ˜610 nm for MoS₂ and ˜625 nm for WS₂ confirm the presence of 2D material as reported in literature (see Backes, C., et al., Edge and confinement effects allow in situ measurements of size and thickness of liquid-exfoliated nanosheets, Nature Communications 5, 4576, 2014).

### Example IX

### Characterization of Specific-Ion-Response of Obtained Dispersions

The solvation of the cationic polymers described herein is governed by the Law of Matching Water Affinity (LMWA). Briefly, LMWA predicts that ion-pairing is dictated by the favorability of interaction between counterions and water. If the interaction between ion and water is energetically more favorable, the ions will be soluble. If the interaction between cation and anion (i.e. ion-pair) is energetically more favorable, the ion-pair will precipitate from solution. The hydration enthalpy (ΔH_{hyd}) provides a convenient measure for predicting the interaction between ions. In the LMWA, if the ΔH_{hyd} between anion and cation is similar, the ion-pair will exist and precipitate from solution as this interaction energetically outcompetes ion-water interactions (i.e., solvation). If there is a mismatch in ΔH_{hyd}, the ions will exist as a solvent separated ion-pair and be soluble, as interaction with water is energetically more favorable. Broadly, this scheme of ion interaction can be thought of as tuning the distance between counterions as a function of ΔH_{hyd}, as the distance between counterions decreases, the ion-pair becomes increasingly less soluble.

The tetraalkyl ammonium motif present on ion-responsive polymers described herein is typically characterized with a low ΔH_{hyd} meaning it forms ion-pairs with anions also characterized with low ΔH_{hyd}, also known as chaotropes. Mixing of salts with a variety of anions characterized with different ΔH_{hyd} confirmed this trend as mixing with salts containing chaotropic anions resulted in increasingly gel-to-solid like materials. Alternatively, mixing with anions characterized with a mismatch of ΔH_{hyd} resulted in fluid-like phases or no modification to solubility. These trends translate to dispersions described herein.

To gain insight into the impact of specific-ion effects on nanomaterial dispersions, phase diagrams were produced as a function of anion identity and concentration. Table 1 below provides the hydration enthalpies of select anions as well as the hydration enthalpy of a tetramethyl ammonium cation, similar to the tetraalkyl ammonium motif on our ion-responsive polymers.

| Ion Identity | Hydration Enthalpy (kJ mol⁻¹) |
|---|---|
| Cl— | 381 |
| Br⁻ | 347 |
| NO₃⁻ | 314 |
| BF₄⁻ | 274 |
| NMe₄⁺ | 251 |

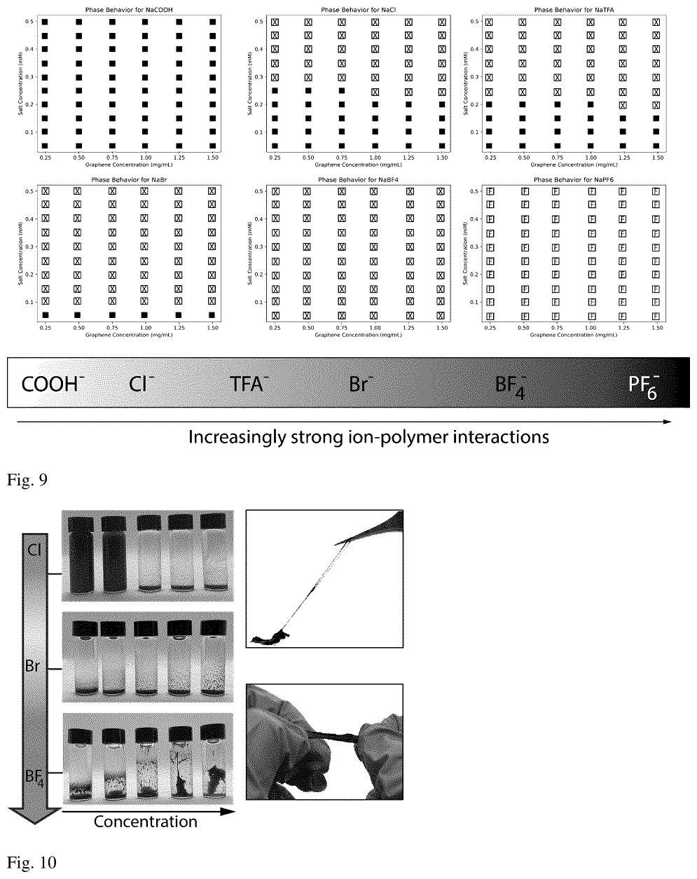

Based on the LMWA, it is expected that ion-pairs should be favored with BF₄ and NO₃⁻ anions while solvent separated pairs should be favored for Cl⁻ and Br⁻. Samples were produced by mixing graphene dispersion, water, and solutions of sodium salts to afford final salt concentrations ranging from 0.1M to 0.5M with a final volume of about 500 uL. Analyzed sodium salts included but not limited to NaHCOO, NaCl, NaBr, NaTFA, NaNO₃, NaBF₄, NaClO₄, NaPF₆, Na₂PdCl₄. The amount of graphene dispersion was varied throughout this study to coincidingly characterize the impact of graphene concentration of phase behavior. Samples were set to shake for 24 hours followed by characterizing the phase behavior by visual analysis. As these systems are in fundamentally time-dependent (i.e. non-equilibrium) states, phase behavior was classified as either no induced phase separation, aqueous two-phase systems (ATPS), or flocculates. FIG. 9 displays the phase diagrams across a variety of anion identities as a function of graphene and salt concentration. For anions that are predicted to have weak interactions with the tetraalkyl ammonium cation, ATPS are observed at moderate salt concentrations (˜0.3M)

Select images of graphene condensates are depicted in FIG. 10. Samples were prepared by mixing graphene dispersion (3.3 mL), DI water, and sodium salts at 2M concentration and letting shake overnight. FIG. 10 demonstrates the impact of anion identity on the solution phase behavior of graphene dispersions. At low chaotropicity (i.e. Cl⁻ anion), condensation is observed only above ˜250 mM. Higher strength chaotropic anions (i.e., Br⁻ and BF₄⁻) induce condensation at much lower concentrations and provide variations in viscoelastic properties. Condensates produced by Cl⁻ and Br⁻ behave as soft, viscous inks when handled (FIG. 10, top right). Condensates produced by BF₄⁻ behave as rubber-like viscoelastic solids.

### Example X

### Probing Specific-Ion Effects Via Zeta Potential Measurements

To gain insight into how anion identity correlates with the affinity of ion-polymer interactions, zeta potential measurements were conducted as a function of anion concentration and identity on graphene dispersions. The zeta potential of colloidal dispersions characterizes the relative charge surrounding a nanoparticle. In the framework of Derjaguin-Landau-Verwey-Overbeek (DLVO) theory, the zeta potential relates to the size of the electrical double layer (EDL). Charged colloidal dispersions display a large EDL at low salt concentration which is correlated with a high zeta potential. As the salt concentration of the solution is increased, the charges on the colloidal particles are screened providing a reduction in EDL and therefore a reduction in zeta potential. The relative affinity is assessed of a specific anion to the tetraalkyl ammonium cation as characterized by the rate of zeta potential decrease across increasing salt concentrations.

Samples for zeta potential measurements were prepared by mixing graphene dispersion, DI water, and sodium salts to obtain a final graphene concentration of 0.1 mg/mL at specific anion concentrations. Samples were let equilibrate overnight prior to measuring on a Malvern Zetasizer Nano ZSP with folded capillary cells of 1 mL volume. FIG. 11 displays the zeta potential of graphene dispersions as a function of anion identity and concentration. Chaotropic anions (i.e. Br⁻ and TFA⁻) provide a steeper reduction in zeta potential at lower concentrations relative to anions of lower chaotropicity (i.e., Cl⁻ and HCOO⁻) The data support that anion chaotropicity (i.e., hydration enthalpy) dictates affinity to the tetraalkyl ammonium motif on ion-responsive polymers.

### Example XI

### Optical and Polarized Optical Microscopy of Nanomaterial Condensates

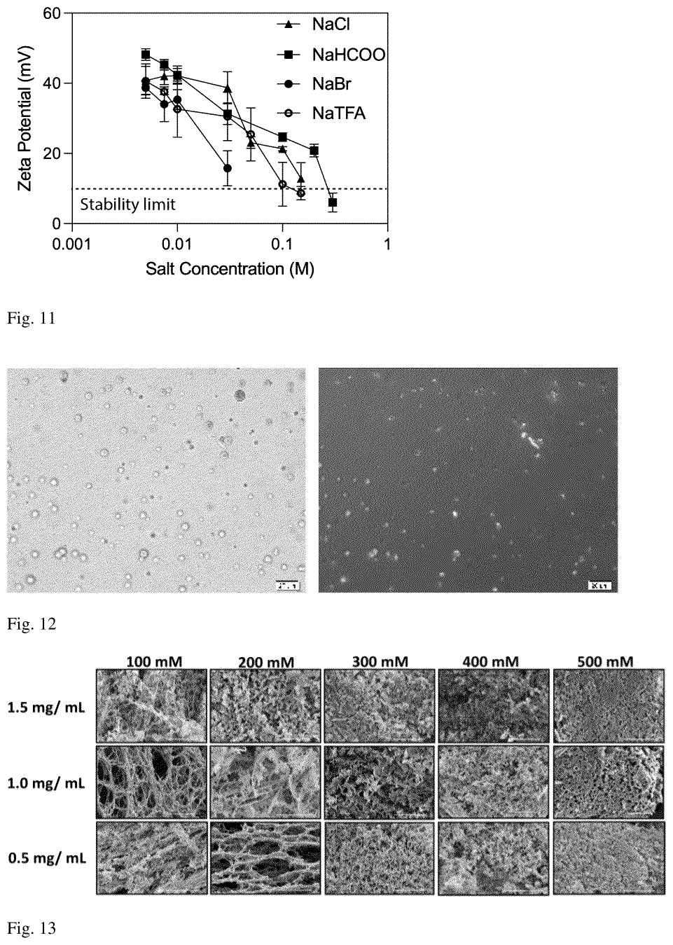

Optical and polarized optical microscopy was used to gain insight into the nature of LLPS within select nanomaterial condensates. Samples were prepared by mixing graphene dispersion, DI water, and sodium salts to achieve a final graphene concentration of 1.5 mg/mL at final salt concentrations ranging from 0.05M to 0.5M. Select images of graphene condensates formed at a concentration of 0.3M NaCl are displayed in FIG. 12. The right panel of FIG. 12 is obtained under a pair of cross-polarizers. The birefringence is indicative of ordering of graphene within the condensates.

To probe the impact of anion identity on the solution phase organization of dispersions, Scanning Electron Microscopy (SEM) was conducted on lyophilized samples. Graphene dispersion, DI water, and salt were mixed in 1-dram vials and set to shake overnight. The next morning, small volume aliquots (˜100 uL) were taken from each sample and flash frozen by immersion ethyl ether/dry ice bath. This cooling bath was used to vitrify (i.e. kinetically trap) the solution phase conformation of each sample for observation under SEM. Samples were sputtered with an about 10 nm layer of Au/Pd prior to imaging on a Thermo Scientific Quattro S-Environmental SEM with an accelerating voltage of 20 kV.

FIG. 13 displays the impact of graphene and NaCl concentration on the solution phase organization of graphene dispersions. Trends observed from this data indicate that the density of material increases as a function of salt concentration indicating enhanced aggregation at elevated salt concentration. This is consistent with a model of ion-induced aggregation, as salt concentration is increased, the electrostatic repulsion between adsorbed polyelectrolyte chains is weakened reducing the distance between nanoparticles and allowing for the formation of intermolecular interactions that reduce water solubility.

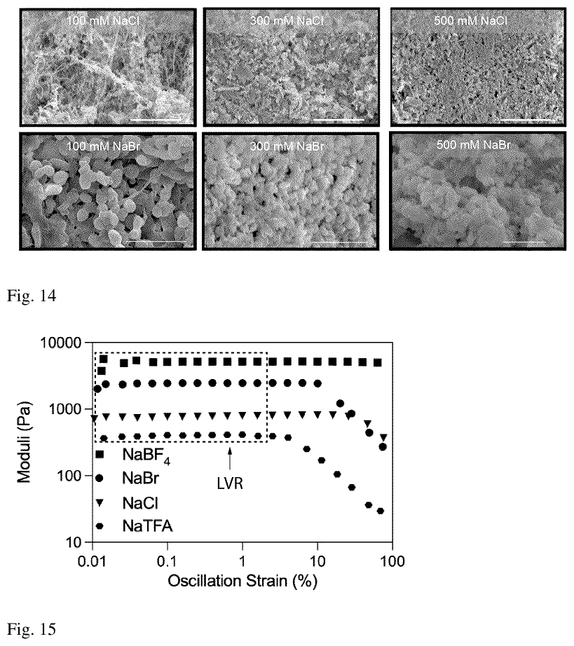

FIG. 14 displays the impact of anion identity and concentration on the solution phase organization of graphene dispersions. Trends from this data suggest that NaBr forms denser networks relative to NaCl owing to enhanced ion-polymer interaction resulting in decreased favorability of polymer-water interactions. Additionally, coacervates are clearly visualized as spherical compartments at 100 mM NaBr. The coacervate structure can be seen undergoing densification at enhanced concentrations of NaBr suggesting that coacervation precedes gelation.

### Example XII

### Rheological Characterization of Nanomaterial Condensates

The viscoelastic, i.e. time-dependent, properties of graphene ATPS were characterized via oscillatory rheology to gain further insight on specific-ion induced modulations to macromolecular dynamics. Viscoelastic behavior represents the combined viscous and elastic contributions within a system under mechanical deformation. Oscillatory rheology provides insight into the relative contributions of each to a system's overall mechanical response by measuring its storage and loss modulus. The storage modulus, G′, represents the elastic component and is correlated with the ability of a system to store and release mechanical energy. This behavior is traditionally associated with solid-like behavior. Alternatively, the loss modulus, G″, represents the viscous component and is correlated with the dissipation of mechanical energy within the system in the form of heat, i.e. the breaking of intermolecular interactions, and is traditionally associated with liquid-like behavior. These parameters are intimately related to the timescales of interaction within the system under characterization. If mechanical deformation occurs on a timescale longer than the characteristic relaxations of the system, liquid-like behavior dominates. Alternatively, if deformation occurs on a shorter timescale relative to relaxation, solid-like behavior dominates. Oscillatory frequency sweeps are utilized to gain insight into the characteristic relaxation processes in a system and provides the relative relaxation timescale determined by the frequency (i.e., timescale) that storage and loss modulus intersect. Systems with strong intermolecular interactions typically have long timescales of relaxation providing solid-like behavior while weaker intermolecular interactions result in quicker timescales of relaxation providing liquid-like behavior.

Oscillation amplitude sweeps were first used to characterize the linear viscoelastic regime of graphene ATPS. The time-dependent properties of soft materials are characterized within the LVR as this regime is correlated with reversible sample deformation meaning the results are reliable and reproducible. Samples were fabricated by the dropwise addition of sodium salts with varying anion identity (2M, 5 mL) to solutions of graphene dispersion (15 mL) resulting in a final salt concentration of 0.5M and nanomaterial concentration of 1.5 mg/mL. Samples were shaken for 24 hours prior to characterization. Samples were then loaded onto a rheometer (Discovery HR20) equipped with an immersion cup Peltier stage adapter and 20 mm parallel plate geometry. Samples were immersed in 0.5M of salt solution used for condensation and trimmed at 10% of final gap height (400 um). Oscillation amplitude sweeps were conducted at an angular frequency of 1.0 rad/s spanning from 0.01% to 100% strain (see FIG. 15). A strain of 0.1% was found to be within the LVR of each sample and used for subsequent angular frequency sweeps.

Oscillation frequency sweeps were conducted with the same rheological setup as oscillation amplitude sweeps. Samples were strained to 0.1% across angular frequencies spanning 0.01 to 500 rad/s. Angular frequency sweeps were conducted in the forward (0.01 to 500 rad/s) and backward (500 to 0.01 rad/s) direction to ensure accurate assessment of viscoelastic properties. FIG. 16 displays the oscillation frequency sweeps with graphene ATPS fabricated from NaCl, NaBr, NaNO₃, and NaBF₄. The dotted line is used as a visual guide to mark the intersection of storage and loss modulus, i.e., the timescale at which the graphene ATPS transitions from behaving as a liquid to behaving as a solid. This timescale, i.e. crossover frequency, was found to be dictated by anion identity. As anion identity trends towards more chaotropic behavior (i.e. BF₄⁻ is most chaotropic out of this series), the crossover frequency shifts towards longer timescales indicating more solid-like behavior. This data demonstrates that anion identity can be used to modulate viscoelastic behavior and that salt swapping enables the transition from fluid-like and processable materials to solid-like freestanding structures.

The viscoelastic properties of soft matter systems are impacted by the temperature at which they are characterized. As temperatures are increased, the relaxations in the system under analysis typically trend towards faster timescales. This rheological principle is known as the Time-Temperature Superposition (TTS) and enables the characterization of viscoelastic properties at experimentally inaccessible timescales. This principle of TTS can be extended to Time-Salt(Type) Superposition (TSS) wherein anion identity serves as the handle to modulate material relaxation timescales akin to temperature in TTS.

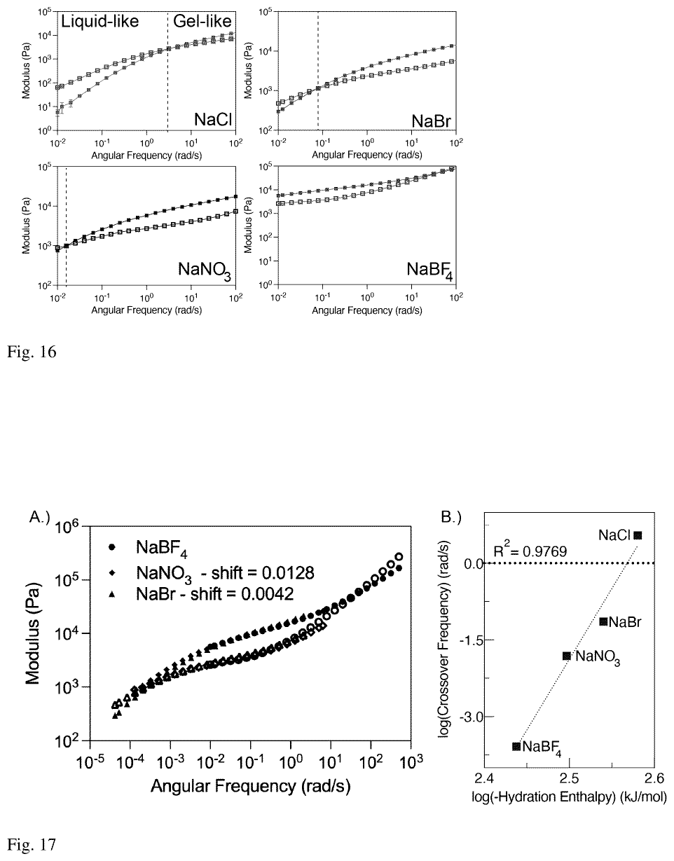

To develop TSS plots, the oscillation frequency sweeps of graphene condensates afforded by NaNO₃ and NaBr were shifted on the x-axis by factors that provided an overlay with the BF₄ data (See FIG. 17). This enabled the characterization of the crossover frequency of the BF₄ condensates. Using the newly obtained data from TSS, an empirical power law was developed that relates macromolecular dynamics (i.e., crossover frequency) to the hydration enthalpy of anions (See FIG. 17). The data presented in FIG. 17 supports using these obtained rules of material manipulation for nanomanufacturing.

### Example XIII

### Characterization of Nanocomposite Microstructure

To characterize the microstructure of obtained nanocomposites, SEM was conducted on air-dried thin-film samples. Prior to SEM analysis, samples were sputtered with an about 10 nm thick coating of Au/Pd. Samples were imaged with an accelerating voltage of 20 kV.

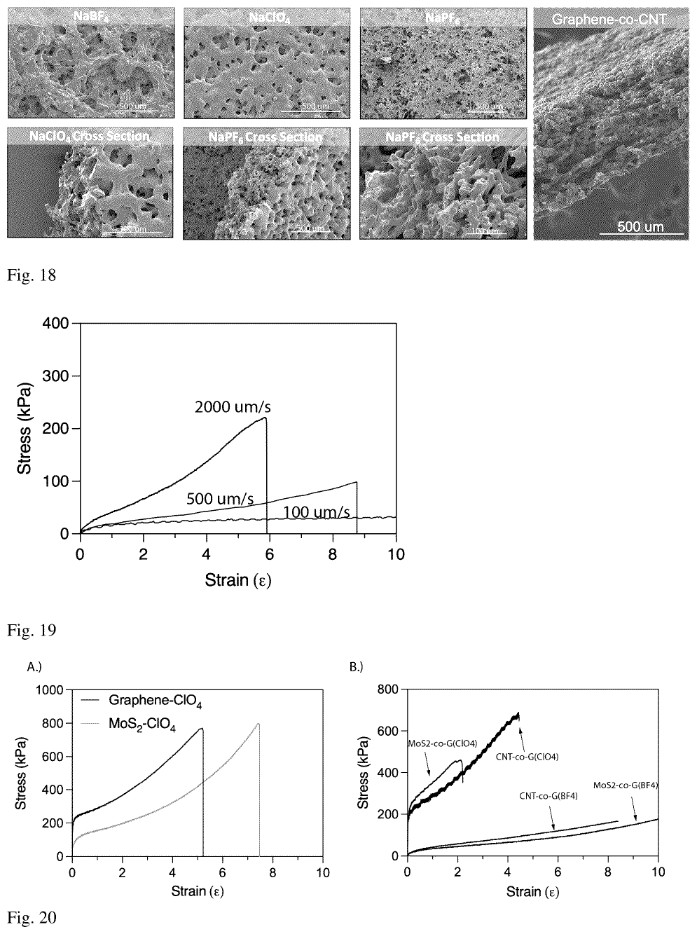

FIG. 18 displays the SEM of a range of graphene and graphene nanocomposite alloys fabricated by the salt-based method described herein. Samples were observed to have a porous, bicontinuous network structure. Thus, these nanocomposites represent templates for the infiltration of additional components comprising of but not limited to additional nanomaterial components, metals, organic solvents, polymerizable solvents, polymers.

### Example XIV

### Mechanical Characterization of Thin-Film Nanocomposites

Tensile testing (Univert CellScale 2.5N load cell) was used to characterize the mechanical properties of nanocomposites fabricated by the salt-based method described herein. Thin-film nanocomposites were cut into dog-bone geometries prior to testing. The displacement rate dependence was first characterized on thin film nanocomposites fabricated using NaBF₄ as a curing salt to identify an optimal displacement rate. FIG. 19 displays the displacement rate dependence of obtained nanocomposites. Higher displacement rates were correlated with enhancements of strength and stiffness. This was hypothesized to arise from the timescale of material deformation becoming increasingly faster than the timescale of material relaxation, thus affording more solid like behavior at higher displacement rates. This is expected in the tensile testing of viscoelastic materials.

As suggested by the power law, anion identity modulates the characteristic relaxation timescale of nanomaterial condensates. To gain insight into how this impacts the mechanical behavior of nanocomposites, a series of thin films were fabricated by the salt-based method described herein with varied identity of curing anion. FIG. 20 shows that anion identity provides nanocomposites with qualitative and quantitative differences in stress-strain plots. Thus, the salt-based method described herein offers a pathway to the fabrication of nanocomposites with programmable mechanics. FIG. 20 demonstrates that salt-based method described herein translates to the fabrication of nanocomposites with varying identity providing materials with similar mechanical characteristics. FIG. 20 demonstrates that complex nanocomposite alloys can be fabricated by the salt-based method described herein from blends of dispersions with mechanics tunable by the composition and identity of curing anion.

### Example XV

### 3D Nanocomposite Fabrication

The general salt swapping strategy of weakly chaotropic to strongly chaotropic anion is used for the 3D casting of nanocomposites. According to one aspect, a method is provided that includes casting mold out of crosslinked poly(acrylamide) followed by injection of nanomaterial condensate into the negative template. Immersion of the casting mold into concentrated salt solutions induces liquid-solid phase separation providing a freestanding 3D nanocomposite.

### Example XVI

### Higher-Order Nanocomposite Fabrication

The colloidal dispersion and/or dispersion blend is mixed with a metal salt and/or metal salts including but not limited to copper halides, magnesium halides, calcium halides, sodium palladates, sodium platinates and the like to form a nanomaterial condensate. Galvanostatic and/or electrodeposition are used to reduce the metal salt onto the formed nanomaterial condensate network resulting in a metal percolated composite.

### Embodiments

A method for forming a nanocomposite by complexing a cationic polymer with a nanomaterial using a salt is provided. The method includes the steps of (a) dispersing a cationic polymer into a solvent; and (b) dispersing a nanomaterial in the solvent; (c) adding salt to form a coacervate of the cationic polymer and the nanomaterial. According to one aspect, the cationic polymer is dispersed in a solvent by stirring, sonicating, or shaking to achieve a homogeneous cationic polymer dispersion prior to inducing the salt switchable cohesion. According to one aspect, the nanomaterial is dispersed in the solvent by stirring, sonicating, shaking, or using a homogenizer to achieve a homogeneous nanomaterial dispersion. According to one aspect, the solvent is selected from any organic solvent, polymerizable organic liquids, and/or water, ethanol, methanol, acetone, dimethyl sulfoxide (DMSO), isopropanol, butanol, and tetrahydrofuran (THF) which is used to disperse cationic polymer and nanomaterial. According to one aspect, the salt switchable cohesion is induced among the cationic polymer dispersion by increasing a salt concentration in the solvent, wherein the salt concentration is increased to a level sufficient to cause the cationic polymer chains to aggregate and form a cohesive network that is capable of interacting with the nanomaterial to form the coacervate. According to one aspect, the salt concentration is increased in the solvent to induce cohesion, specifically, the salt concentration is increased gradually while monitoring the viscosity of the cationic polymer dispersion to ensure that the desired level of cohesion is achieved without precipitating the cationic polymer. According to one aspect, the coacervate is formed by the nanomaterial by cohesion with the cationic polymer, and this process involves the nanomaterial being attracted to and encapsulated by the cohesive network of cationic polymer chains, resulting in a stable coacervate structure. According to one aspect, the method further includes adjusting the salt concentration to control the size of the coacervate, wherein the adjustment of the salt concentration is performed to achieve a coacervate size that is tailored for specific applications, such as drug delivery, catalysis, or sensor technology. According to one aspect, the method further includes adjusting the salt concentration to control the density of the coacervate, wherein the adjustment of the salt concentration is performed to achieve a specific organization and long-range alignment of the constituent nanomaterial that is consistent and reproducible for the intended application of the nanocomposite. According to one aspect, the method further includes adjusting the salt concentration to control the density of the coacervate, wherein the density adjustment is critical for applications where the buoyancy or sedimentation rate of the coacervate in the solvent impacts the performance of the nanocomposite. According to one aspect, the method further includes using a specific type of cationic polymer to influence the properties of the nanocomposite, wherein the choice of cationic polymer is based on its molecular weight, topology, charge density, and compatibility with the nanomaterial, which collectively contribute to the mechanical strength, thermal stability, and functional performance of the nanocomposite.

A system for forming a nanocomposite is described herein. The system includes a cohesion inducer capable of complexing a cationic polymer with a nanomaterial via a salt induced assembly. The system includes (1) a concentration adjuster configured for dispersing a cationic polymer into a solvent and inducing a salt switchable cohesion among the cationic polymer dispersion by increasing a salt concentration in the solvent; and (2) a coacervate former configured for dispersing a nanomaterial in the solvent and for forming a coacervate by a cohesion with the cationic polymer. According to one aspect, the component mixer is configured to disperse the cationic polymer in a solvent by employing techniques such as stirring, sonicating, or shaking to ensure a uniform distribution of the cationic polymer within the solvent, thereby facilitating the subsequent salt switchable cohesion process. According to one aspect, the component mixer is configured to disperse the nanomaterial in the solvent by employing techniques such as stirring, sonicating, shaking, or using a homogenizer to ensure a uniform distribution of the nanomaterial within the solvent, thereby facilitating the subsequent interaction with the cationic polymer to form the coacervate. According to one aspect, the component mixer is configured to use a solvent including at least one of water, ethanol, methanol, acetone, dimethyl sulfoxide (DMSO), isopropanol, butanol, and tetrahydrofuran (THF) to disperse both the cationic polymer and the nanomaterial, ensuring a homogeneous mixture for the formation of the coacervate. According to one aspect, the cohesion inducer is configured to induce salt switchable cohesion among the cationic polymer dispersion by increasing a salt concentration in the solvent, which is precisely controlled to achieve the desired level of cohesion necessary for the optimal interaction with the nanomaterial and the formation of a stable coacervate. According to one aspect, the concentration adjuster is configured to increase the salt concentration in the solvent to induce cohesion, with the capability to fine-tune the salt concentration to modulate the properties of the resulting coacervate, such as its size, density, and stability, thereby allowing for the customization of the nanocomposite characteristics. According to one aspect, the coacervate former is configured to form a coacervate by the nanomaterial by cohesion with the cationic polymer, ensuring that the coacervate formation is efficient and reproducible, leading to a consistent quality of the nanocomposite product. According to one aspect, the concentration adjuster is configured to adjust the salt concentration to control the size of the coacervate, providing a means to produce coacervates with a predetermined size range that is consistent and reproducible for the intended application of the nanocomposite. According to one aspect, the concentration adjuster is configured to adjust the salt concentration to control the density of the coacervate, enabling the production of coacervates with specific densities that are optimized for their intended use in various industrial or biomedical applications. According to one aspect, the component mixer is configured to use a specific type of cationic polymer to influence the properties of the nanocomposite, wherein the selection of the cationic polymer is guided by the desired characteristics of the nanocomposite, such as its electrical conductivity, magnetic responsiveness, or optical clarity.

A nanocomposite including a cationic polymer bonded with a nanomaterial via an ionic cohesion formed by a salt induced assembly is described herein. According to one aspect, the cationic polymer includes a salt switchable cohesion between the cationic polymer and the nanomaterial formed by increasing a salt concentration in a solvent including a dispersion of the nanomaterial and the cationic polymer; wherein the nanomaterial is in the form of a coacervate by the ionic cohesion with the cationic polymer. According to one aspect, the cationic polymer and the nanomaterial are selected such that the ionic cohesion between them provides a stable nanocomposite structure under predetermined conditions, and wherein the cationic polymer is characterized by a molecular weight and charge density optimized to enhance the stability and mechanical properties of the nanocomposite, and the nanomaterial is chosen for its specific surface area, particle size, and functionalization to contribute to the overall properties of the nanocomposite. According to one aspect, the nanocomposite further includes additional components that modify the physical, chemical, or electrical properties of the nanocomposite, such as plasticizers, stabilizers, conductive fillers, and other polymers that are compatible with the cationic polymer and nanomaterial. According to one aspect, the nanocomposite exhibits enhanced thermal stability due to the ionic cohesion between the cationic polymer and the nanomaterial, which is achieved through the careful selection of the cationic polymer's molecular structure and the nanomaterial's thermal properties to resist degradation at elevated temperatures. According to one aspect, the nanocomposite demonstrates improved mechanical strength as a result of the optimized molecular weight and charge density of the cationic polymer, which contributes to a robust network formation with the nanomaterial, enhancing the load-bearing capacity of the composite. According to one aspect, the nanocomposite possesses increased electrical conductivity facilitated by the inclusion of conductive fillers within the matrix, which are distributed in such a manner to create pathways for electron flow, thereby improving the electrical performance of the composite material. According to one aspect, the nanocomposite maintains its structural integrity under extreme environmental conditions due to the stability of the ionic cohesion, which is designed to withstand factors such as high temperatures, humidity, and exposure to harsh chemicals. According to one aspect, the nanocomposite is utilized in applications requiring biocompatibility, the cationic polymer and nanomaterial being selected based on their biocompatible properties, ensuring that the composite is non-toxic and safe for use in medical devices and implants. According to one aspect, the nanocomposite is designed for use in electronic devices, the properties of the cationic polymer and nanomaterial being tailored to meet the specific requirements of electronic applications, including flexibility, conductivity, and durability. According to one aspect, the nanocomposite includes a functionalization of the nanomaterial to specifically interact with targeted molecules, providing a means for selective binding or detection in chemical sensors, which enhances the sensitivity and specificity of the sensors.

A method for forming a nanocomposite is provided including the steps of (a) combining a cationic polymer and a solvent; (b) combining a nanomaterial and the solvent; (c) combining the cationic polymer and the nanomaterial; (d) forming a dispersion of the combined cationic polymer and the nanomaterial, and (e) forming a coacervate of the nanomaterial and the cationic polymer by adding salt to the dispersion. According to one aspect, the cationic polymer includes one or more ionically responsive monomeric structures comprising acrylate, acrylamide, vinylic, or ring-strained polymerizable motifs and similar analogues bearing ammonium, imidazolium, azolium, pyridinium, or other cationic analogues. According to one aspect, the cationic polymer includes one or more co-monomers comprising acrylamide, N,N-dimethyl acrylamide, N-Isopropyl acrylamide, benzyl acrylamide, methyl acrylate, n-butyl acrylate, N,N-dimethyl amino ethyl acrylate, vinyl imidazole and other analogues capable of being polymerized with the ionically responsive monomer. According to one aspect, the nanomaterial comprises one or more of carbon-based nanomaterials, such as graphene, carbon nanotubes, buckyballs, and carbon microfibers, hexagonal boron nitride, boron nitride nanotubes, transition metal dichalcogenides, metal oxides, MXenes, cellulose nanocrystals, cellulose microfibers, hydroxyapaptite nanocrystals, and transition metal based nanomaterials such as gold nanowires, copper nanocubes, or cadmium selenide nanoparticles. According to one aspect, the salt comprises a cation-anion pair comprised from cationic lithium, sodium, potassium, magnesium, calcium, copper, nickel, silver, gold, iron and anionic chloride, bromide, trifluoroacetate, nitrate, tetrafluoroborate, perchlorate, hexafluorophosphate, sulfate, 3,5-pyrocatecholdisulfonate tetrachloropalladate, and other analogues of anionic transition metal-based complexes. According to one aspect, the solvent comprises a polar solvent. According to one aspect, the solvent comprises an organic solvent. According to one aspect, the solvent comprises a polymerizable organic solvent. According to one aspect, the solvent comprises one or more of polar solvents, organic solvents and polymerizable organic liquids, such as water, ethanol, methanol, acetone, dimethyl sulfoxide (DMSO), isopropanol, butanol, tetrahydrofuran (THF), N,N-dimethylformamide, acetonitrile, 1,2-ethanedithiol and other di-, tri- and tetra-thiol analogues, ethylene oxide, propylene oxide and other epoxide bearing analogues, 4,4′-diphenylmethane diisocyante, 2,6-tolune diisocyante, methyl ester lysine diisociante and diisocyanate bearing analogs and the like which are used to disperse cationic polymer, nanomaterial or both. According to one aspect, the method further includes adding one or more additional components comprising a plasticizer, a stabilizer, a conductive filler, or a further polymer that is compatible with the cationic polymer and nanomaterial. According to one aspect, the coacervate is characterized by an aggregated polymer chain matrix encompassing the nanomaterial. According to one aspect, the salt concentration is increased without precipitating the cationic polymer. According to one aspect, the nanomaterial is attracted to and encapsulated by the cohesive network of cationic polymer chains, resulting in a stable coacervate structure. According to one aspect, the method further includes adjusting the salt concentration to control the size of the coacervate. According to one aspect, the method further includes adjusting the salt concentration to control the density of the coacervate. According to one aspect, the method further includes adding an additional salt to form a solid material using liquid solid phase separation.

A system for forming a nanocomposite is provided where the system includes a cohesion inducer capable of complexing a cationic polymer with a nanomaterial via a salt induced assembly, the cohesion inducer comprising: (1) a concentration adjuster configured for dispersing a cationic polymer into a solvent and inducing a salt switchable cohesion among the cationic polymer dispersion by increasing a salt concentration in the solvent; and (2) a coacervate former configured for dispersing a nanomaterial in the solvent and for forming a coacervate by a cohesion with the cationic polymer. According to one aspect, the system further includes a component mixer configured to disperse the cationic polymer in a solvent by stirring, sonicating, or shaking to ensure a uniform distribution of the cationic polymer within the solvent, thereby facilitating the subsequent salt switchable cohesion process. According to one aspect, the component mixer is a homogenizer. According to one aspect, the cohesion inducer is configured to induce salt switchable cohesion among the cationic polymer dispersion by increasing a salt concentration in the solvent, which is controlled to achieve a desired level of cohesion between the cationic polymer and the nanomaterial to form a stable coacervate. According to one aspect, the concentration adjuster is configured to increase the salt concentration in the solvent to induce cohesion, and to modulate the size, density, or stability of the resulting coacervate. According to one aspect, the coacervate former is configured to form a coacervate by the nanomaterial by cohesion with the cationic polymer. According to one aspect, the concentration adjuster is configured to adjust the salt concentration to control the size of the coacervate. According to one aspect, the concentration adjuster is configured to adjust the salt concentration to control the density of the coacervate.

A nanocomposite is provided including a cationic polymer bonded with a nanomaterial via an ionic cohesion; wherein the nanomaterial is a coacervate formed by addition of salt to a dispersion of the cationic polymer and the nanomaterial resulting in ionic between the nanomaterial and the cationic polymer.

All patents and publications cited throughout this specification are incorporated by reference to disclose and describe the materials and methods that might be used with the technologies described in this specification. The publications discussed are provided for their disclosure before the filing date. They should not be construed as an admission that the inventors may not antedate such disclosure under prior invention or for any other reason. If there is an apparent discrepancy between a prior patent or publication and the description provided in this specification, the specification (including any definitions) and claims shall control. The statements about the date or contents of these documents are based on the information available to the applicants. These statements constitute no admission to the correctness of the dates or contents of these documents. The publication dates provided in this specification may differ from the actual publication dates. If there is an apparent discrepancy between a publication date provided in this specification and the actual publication date supplied by the publisher, the actual publication date shall control.

1. A method for forming a nanocomposite comprising
(a) combining a cationic polymer and a solvent;
(b) combining a nanomaterial and the solvent;
(c) combining the cationic polymer and the nanomaterial;
(d) forming a dispersion of the combined cationic polymer and the nanomaterial, and
(e) forming a coacervate of the nanomaterial and the cationic polymer by adding salt to the dispersion.

2. The method of claim 1 wherein the cationic polymer includes one or more ionically responsive monomeric structures comprising acrylate, acrylamide, vinylic, or ring-strained polymerizable motifs and similar analogues bearing ammonium, imidazolium, azolium, pyridinium, or other cationic analogues.

3. The method of claim 2 wherein the cationic polymer includes one or more co-monomers comprising acrylamide, N,N-dimethyl acrylamide, N-Isopropyl acrylamide, benzyl acrylamide, methyl acrylate, n-butyl acrylate, N,N-dimethyl amino ethyl acrylate, vinyl imidazole and other analogues capable of being polymerized with the ionically responsive monomer.

4. The method of claim 1 wherein the nanomaterial comprises one or more of carbon-based nanomaterials, such as graphene, carbon nanotubes, buckyballs, and carbon microfibers, hexagonal boron nitride, boron nitride nanotubes, transition metal dichalcogenides, metal oxides, MXenes, cellulose nanocrystals, cellulose microfibers, hydroxyapaptite nanocrystals, and transition metal-based nanomaterials such as gold nanowires, copper nanocubes, or cadmium selenide nanoparticles.

5. The method of claim 1 wherein the salt comprises a cation-anion pair comprised from cationic lithium, sodium, potassium, magnesium, calcium, copper, nickel, silver, gold, iron and anionic chloride, bromide, trifluoroacetate, nitrate, tetrafluoroborate, perchlorate, hexafluorophosphate, sulfate, 3,5-pyrocatecholdisulfonate tetrachloropalladate, and other analogues of anionic transition metal-based complexes.

6. The method of claim 1, wherein the solvent comprises a polar solvent.

7. The method of claim 1, wherein the solvent comprises an organic solvent.

8. The method of claim 1, wherein the solvent comprises a polymerizable organic solvent.

9. The method of claim 1 wherein the solvent comprises one or more of polar solvents, organic solvents and polymerizable organic liquids, such as water, ethanol, methanol, acetone, dimethyl sulfoxide (DMSO), isopropanol, butanol, tetrahydrofuran (THF), N,N-dimethylformamide, acetonitrile, 1,2-ethanedithiol and other di-, tri- and tetra-thiol analogues, ethylene oxide, propylene oxide and other epoxide bearing analogues, 4,4′-diphenylmethane diisocyante, 2,6-tolune diisocyante, methyl ester lysine diisociante and diisocyanate bearing analogs and the like which are used to disperse cationic polymer, nanomaterial or both.

10. The method of claim 1 further including one or more additional components comprising a plasticizer, a stabilizer, a conductive filler, or a further polymer that is compatible with the cationic polymer and nanomaterial.

11. The method of claim 1 wherein the coacervate is characterized by an aggregated polymer chain matrix encompassing the nanomaterial.

12. The method of claim 1, wherein the salt concentration is increased without precipitating the cationic polymer.

13. The method of claim 1, wherein the nanomaterial is attracted to and encapsulated by the cohesive network of cationic polymer chains, resulting in a stable coacervate structure.

14. The method of claim 1, further comprising adjusting the salt concentration to control the size of the coacervate.

15. The method of claim 1, further comprising adjusting the salt concentration to control the density of the coacervate.

16. The method of claim 1, further comprising adding an additional salt to form a solid material using liquid solid phase separation.

17. A system for forming a nanocomposite, the system comprising a cohesion inducer capable of complexing a cationic polymer with a nanomaterial via a salt induced assembly, the cohesion inducer comprising: (1) a concentration adjuster configured for dispersing a cationic polymer into a solvent and inducing a salt switchable cohesion among the cationic polymer dispersion by increasing a salt concentration in the solvent; and (2) a coacervate former configured for dispersing a nanomaterial in the solvent and for forming a coacervate by a cohesion with the cationic polymer.

18. The system of claim 17, further comprising a component mixer configured to disperse the cationic polymer in a solvent by stirring, sonicating, or shaking to ensure a uniform distribution of the cationic polymer within the solvent, thereby facilitating the subsequent salt switchable cohesion process.

19. The system of claim 17, wherein the component mixer is a homogenizer.

20. The system of claim 17, wherein the cohesion inducer is configured to induce salt switchable cohesion among the cationic polymer dispersion by increasing a salt concentration in the solvent, which is controlled to achieve a desired level of cohesion between the cationic polymer and the nanomaterial to form a stable coacervate.

21. The system of claim 17, wherein the concentration adjuster is configured to increase the salt concentration in the solvent to induce cohesion, and to modulate the size, density, or stability of the resulting coacervate.

22. The system of claim 17, wherein the coacervate former is configured to form a coacervate by the nanomaterial by cohesion with the cationic polymer.

23. The system of claim 17, wherein the concentration adjuster is configured to adjust the salt concentration to control the size of the coacervate.

24. The system of claim 17, wherein the concentration adjuster is configured to adjust the salt concentration to control the density of the coacervate.

25. A nanocomposite comprising a cationic polymer bonded with a nanomaterial via an ionic cohesion; wherein the nanomaterial is a coacervate formed by addition of salt to a dispersion of the cationic polymer and the nanomaterial resulting in ionic between the nanomaterial and the cationic polymer.
